(19) United States
(12) Patent Application Publication
(10) Pub. No.: US 2004/0173696 A1
(43) Pub. Date: Sep. 9, 2004

(54) Milling microgram quantities of nanoparticulate candidate compounds

(75) Inventors: James Cunningham, Paoli, PA (US); Elaine Liversidge, West Chester, PA (US); Eugene R. Cooper, Berwyn, PA (US); Gary G. Liversidge, West Chester, PA (US)

Correspondence Address: FOLEY AND LARDNER, SUITE 500, 3000 K STREET NW, WASHINGTON, DC, 20007, US

(73) Assignee: Elan Pharma International Ltd.

(21) Appl. No.: 10/736,989

(22) Filed: Dec. 17, 2003

Related U.S. Application Data
(60) Provisional application No. 60/433,784, filed on Dec. 17, 2002.

(51) Int. Cl. B02C 19/12

(52) U.S. Cl. 241/21

(57) ABSTRACT

The present invention is directed to a method of milling small quantities of one or more candidate compounds to reduce the particle size of at least one candidate compound to about 2 microns or less. The apparatus used for the milling process can be one or more multi-well plates, or any other suitable apparatus. The resultant products are dispersions of nanoparticulate candidate compounds. The method is particularly suited for increasing the effectiveness of high throughput screening (“HTS”).

### CROSS-REFERENCE TO RELATED APPLICATIONS

This application claims benefit of U.S. provisional application No. 60/433,784, filed on Dec. 17, 2002.

### BACKGROUND OF THE INVENTION

The present invention relates generally to a method of milling small quantities of one or more candidate compounds to reduce the effective average particle size of the compounds to less than about 2 microns. The method utilizes an apparatus that has a compartment that can contain the candidate compound and any other components to be milled. Multiple candidate compounds can be simultaneously milled utilizing an apparatus that has multiple compartments. The methods of the invention can be used in conjunction with high throughput screening methods of the candidate compounds.

A. Milling of Pharmaceutical Compositions

The micronization method of grinding drug compounds to achieve a smaller particle size is well established. Conventional milling techniques, such as jet mill or rotor stator colloid mills, grind drugs into powders that have particle sizes ranging from 0.1 μm to 25 μm. Wet media mills, such as the ones described in U.S. Pat. Nos. 5,797,550 and 4,848,676, are generally used to mill or grind relatively large quantities of materials. These rather large media mills are not generally suitable for grinding small or minute quantities, such as that required for samples to be used in or generated from High Throughput Screening (HTS). U.S. Pat. No. 5,593,097 recognizes the need for milling small quantities, as small as 0.25 grams, to a size less than 0.5 micron to about 0.05 micron (average diameter) in about 60 minutes.

There are several research groups and companies developing and manufacturing micro-, mini-, and nanomills. For example, W. A. Bachofen, in Switzerland manufactures the DYNO®-Mill, a continuously operating bead mill with a horizontal grinder container. Bachofen make a variety of DYNO®-Mills with different specifications, such as a small laboratory model (DYNO®-Mill KDL A) which accommodates 0.15-0.3 liter grinding containers for discontinuous operation, and 0.3-0.6 liters for continuous operation. The grinding beads are spherical and have a diameter of 0.2-1.5 mm. The power output of the mill motor is 1.5-1.85 kW. One of the preferred application fields for this particular DYNO®-Mill is for mechanical cell disruption in microbiology and biochemistry. At the other end of the size and volume range is the DYNO®-Mill KD 600 that has grinders with a volume capacity of 600 liters.

A specially developed, high efficiency, bead mill for dispersion and wet grinding applications uses Bachofen's “newly developed DYNO® accelerators” (DYNO®-Mill ECM). The ECM-Pilot version accommodates 1.5 liters and has a motor output of 6.8-7.5 kW; the ECM-Pro model has a capacity of 1 8.2 liters and outputs 36-45 kW. In addition, the company also has an apparatus (TURBULA®) that mixes powdery substances with differing specific weights and particle sizes, and is convenient for use in the pharmaceutical industry.

Netzsch, Inc. make the LMZ Zeta System, which has a high energy, high flow, multiple pass grinding mechanism to achieve submicron size particles. Their Dynamic Cartridge Media Separator™ (DCMS) allows the use of grinding media as small as 100 μm in size. The different models can accommodate from 1.6 liters to 62 liters of suspension. One model, the MiniZeta is a high energy grinding system for small batch analysis. In this particular model, the batch size is 250 ml with a chamber volume of 300 ml. Yet another, the Laboratory Attrition Mill is designed for very small quantities of material, wherein the grinding vessel is jacketed for cooling or heating.

MicroGrinding Systems, Inc. have made a Vibrokinetic Energy Grinding Mill, which is an “extremely fast and very energy efficient” milling machine that can be operated either wet or dry. This particular mill uses a tuned spring system to suspend the grinding chamber and motor energy source. This saves and reuses “rebound” energy and makes the mill cost-effective and maintenance-free, especially since the motor is the only moving part, so energy expenditure and power maintenance are minimal. Adjustable air cyclone classifiers separate product streams in the 5-10 micron range.

The mill is available in several basic models, including a Laboratory Mill “capable of producing 50 pounds per hour of fine product from a ¼” feed, and a Pilot Plant Mill which produces 250 pounds per hour of fine powder from ¼″ hard feed material. The company suggests pharmaceuticals can be ground using these apparatus.

Nanoscale Combinatorial Synthesis, Inc. (Nanosyn) is publicizing their Accelerated Nanoscale Synthesis Technology (ANST™) technology, which enables screening of compounds in miniaturized assays. Their proprietary products and services were publicized in January, 2001 when the company announced it will provide small molecule libraries to Euroscreen, a Belgium-based molecular diagnostic company.

Finally, a small scale mill exhibiting improvements over prior art technology is described in U.S. Pat. No. 6,431,478 for “Small Scale Mill”, which is specifically incorporated by reference.

B. Milling to Obtain Nanoparticulate Compositions

Reducing the particle size of an candidate compound can be useful for increasing the solubility of the active agent, as a reduction in particle size correlates to an increase in surface area. This is significant, as pharmaceutical active agents that exhibit poor solubility often can diminish the efficacy of a drug formulation.

Milling of active agents to a nanoparticulate particle size is described, for example, in U.S. Pat. No. 5,145,684 “for Surface Modified Drug Nanoparticles;” U.S. Pat. No. 5,298,262 for “Use of Ionic Cloud Point Modifiers to Prevent Particle Aggregation During Sterilization;” U.S. Pat. No. 5,302,401 for “Method to Reduce Particle Size Growth During Lyophilization;” U.S. Pat. No. 5,318,767 for “X-Ray Contrast Compositions Useful in Medical Imaging;” U.S. Pat. No. 5,326,552 for “Novel Formulation For Nanoparticulate X-Ray Blood Pool Contrast Agents Using High Molecular Weight Non-ionic Surfactants;” U.S. Pat. No. 5,328,404 for “Method of X-Ray Imaging Using Iodinated Aromatic Propanedioates;” U.S. Pat. No. 5,336,507 for “Use of Charged Phospholipids to Reduce Nanoparticle Aggregation;” U.S. Pat. No. 5,340,564 for “Formulations Comprising Olin 10-G to Prevent Particle Aggregation and Increase Stability;” U.S. Pat. No. 5,346,702 for “Use of Non-Ionic Cloud Point Modifiers to Minimize Nanoparticulate Aggregation During Sterilization;” U.S. Pat. No. 5,349,957 for “Preparation and Magnetic Properties of Very Small Magnetic-Dextran Particles;” U.S. Pat. No. 5,352,459 for “Use of Purified Surface Modifiers to Prevent Particle Aggregation During Sterilization;” U.S. Pat. No. 5,399,363 for “Surface Modified Anticancer Nanoparticles;” U.S. Pat. No. 5,401,492 for “Water Insoluble Non-Magnetic Manganese Particles as Magnetic Resonance Enhancement Agents;” U.S. Pat. No. 5,429,824 for “Use of Tyloxapol as a Nanoparticulate Stabilizer;” U.S. Pat. No. 5,447,710 for “Method for Making Nanoparticulate X-Ray Blood Pool Contrast Agents Using High Molecular Weight Non-ionic Surfactants;” U.S. Pat. No. 5,451,393 for “X-Ray Contrast Compositions Useful in Medical Imaging;” U.S. Pat. No. 5,466,440 for “Formulations of Oral Gastrointestinal Diagnostic X-Ray Contrast Agents in Combination with Pharmaceutically Acceptable Clays;” U.S. Pat. No. 5,470,583 for “Method of Preparing Nanoparticle Compositions Containing Charged Phospholipids to Reduce Aggregation;” U.S. Pat. No. 5,472,683 for “Nanoparticulate Diagnostic Mixed Carbamic Anhydrides as X-Ray Contrast Agents for Blood Pool and Lymphatic System Imaging;” U.S. Pat. No. 5,494,683 for “Surface Modified Anticancer Nanoparticles;” U.S. Pat. No. 5,500,204 for “Nanoparticulate Diagnostic Dimers as X-Ray Contrast Agents for Blood Pool and Lymphatic System Imaging;” U.S. Pat. No. 5,518,187 for “Method of Grinding Pharmaceutical Substances;” U.S. Pat. No. 5,518,738 for “Nanoparticulate NSAID Formulations;” U.S. Pat. No. 5,521,218 for “Nanoparticulate Iododipamide Derivatives for Use as X-Ray Contrast Agents;” U.S. Pat. No. 5,525,328 for “Nanoparticulate Diagnostic Diatrizoxy Ester X-Ray Contrast Agents for Blood Pool and Lymphatic System Imaging;” U.S. Pat. No. 5,543,133 for “Process of Preparing X-Ray Contrast Compositions Containing Nanoparticles;” U.S. Pat. No. 5,552,160 for “Surface Modified NSAID Nanoparticles;” U.S. Pat. No. 5,560,931 for “Formulations of Compounds as Nanoparticulate Dispersions in Digestible Oils or Fatty Acids;” U.S. Pat. No. 5,565,188 for “Polyalkylene Block Copolymers as Surface Modifiers for Nanoparticles;” U.S. Pat. No. 5,569,448 for “Sulfated Non-ionic Block Copolymer Surfactant as Stabilizer Coatings for Nanoparticle Compositions;” U.S. Pat. No. 5,571,536 for “Formulations of Compounds as Nanoparticulate Dispersions in Digestible Oils or Fatty Acids;” U.S. Pat. No. 5,573,749 for “Nanoparticulate Diagnostic Mixed Carboxylic Anydrides as X-Ray Contrast Agents for Blood Pool and Lymphatic System Imaging;” U.S. Pat. No. 5,573,750 for “Diagnostic Imaging X-Ray Contrast Agents;” U.S. Pat. No. 5,573,783 for “Redispersible Nanoparticulate Film Matrices With Protective Overcoats;” U.S. Pat. No. 5,580,579 for “Site-specific Adhesion Within the GI Tract Using Nanoparticles Stabilized by High Molecular Weight, Linear Poly(ethylene Oxide) Polymers;” U.S. Pat. No. 5,585,108 for “Formulations of Oral Gastrointestinal Therapeutic Agents in Combination with Pharmaceutically Acceptable Clays;” U.S. Pat. No. 5,587,143 for “Butylene Oxide-Ethylene Oxide Block Copolymers Surfactants as Stabilizer Coatings for Nanoparticulate Compositions;” U.S. Pat. No. 5,591,456 for “Milled Naproxen with Hydropropyl Cellulose as Dispersion Stabilizer;” U.S. Pat. No. 5,593,657 for “Novel Barium Salt Formulations Stabilized by Non-ionic and Anionic Stabilizers;” U.S. Pat. No. 5,622,938 for “Sugar Based Surfactant for Nanocrystals;” U.S. Pat. No. 5,628,981 for “Improved Formulations of Oral Gastrointestinal Diagnostic X-Ray Contrast Agents and Oral Gastrointestinal Therapeutic Agents;” U.S. Pat. No. 5,643,552 for “Nanoparticulate Diagnostic Mixed Carbonic Anhydrides as X-Ray Contrast Agents for Blood Pool and Lymphatic System Imaging;” U.S. Pat. No. 5,718,388 for “Continuous Method of Grinding Pharmaceutical Substances;” U.S. Pat. No. 5,718,919 for “Nanoparticles Containing the R(−)Enantiomer of Ibuprofen;” U.S. Pat. No. 5,747,001 for “Aerosols Containing Beclomethasone Nanoparticle Dispersions;” U.S. Pat. No. 5,834,025 for “Reduction of Intravenously Administered Nanoparticulate Formulation Induced Adverse Physiological Reactions;” U.S. Pat. No. 6,045,829 “Nanocrystalline Formulations of Human Immunodeficiency Virus (HIV) Protease Inhibitors Using Cellulosic Surface Stabilizers;” U.S. Pat. No. 6,068,858 for “Methods of Making Nanocrystalline Formulations of Human Immunodeficiency Virus (HIV) Protease Inhibitors Using Cellulosic Surface Stabilizers;” U.S. Pat. No. 6,153,225 for “Injectable Formulations of Nanoparticulate Naproxen;” U.S. Pat. No. 6,165,506 for “New Solid Dose Form of Nanoparticulate Naproxen;” and 6,221,400 for “Methods of Treating Mammals Using Nanocrystalline Formulations of Human Immunodeficiency Virus (HIV) Protease Inhibitors;” U.S. Pat. No. 6,264,922 for “Nebulized Aerosols Containing Nanoparticle Dispersions;” U.S. Pat. No. 6,267,989 for “Methods for Preventing Crystal Growth and Particle Aggregation in Nanoparticle Compositions;” U.S. Pat. No. 6,270,806 for “Use of PEG-Derivatized Lipids as Surface Stabilizers for Nanoparticulate Compositions;” and 6,316,029 for “Rapidly Disintegrating Solid Oral Dosage Form;” U.S. Pat. No. 6,375,986 for “Solid Dose Nanoparticulate Compositions Comprising a Synergistic Combination of a Polymeric Surface Stabilizer and Dioctyl Sodium Sulfosuccinate,” U.S. Pat. No. 6,428,814 for “Bioadhesive Nanoparticulate Compositions Having Cationic Surface Stabilizers;” U.S. Pat. No. 6,431,478 for “Small Scale Mill;” U.S. Pat. No. 6,432,381 for “Methods for Targeting Drug Delivery to the Upper and/or Lower Gastrointestinal Tract,” U.S. Pat. No. 6,592,903 for “Nanoparticulate dispersions comprising a synergistic combination of a polymeric surface stabilizer and dioctyl sodium Sulfosuccinate;” U.S. Pat. No. 6,582,285 for “Apparatus for sanitary wet milling;” U.S. Pat. No. 6,656,504 for “Nanoparticulate compositions comprising amorphous cyclosporine and methods of making and using such compositions;” all of which are specifically incorporated by reference. In addition, U.S. patent application No. 20020012675 A1, published on Jan. 31, 2002, for “Controlled Release Nanoparticulate Compositions,” and WO 02/098565 for “System and Method for Milling Materials,” describe nanoparticulate active agent compositions, and are specifically incorporated by reference. None of these references describe nanoparticulate milling microgram quantities of nanoparticulate candidate compounds.

C. Background Relating to High Throughput Screening

Drug discovery relies on the ability to identify compounds that interact with a selected target, such as cells, an antibody, receptor, enzyme, transcription factor, or the like. Traditional drug discovery relied on collections or “libraries” obtained from proprietary databases of compounds accumulated over many years, natural products, fermentation broths, and rational drug design. Recent advances in molecular biology, chemistry, and automation have resulted in the development of rapid, HTS protocols to screen these collections. HTS and sample preparation can account for about 1% (about US $2.7 million) of the cost associated with the development of a drug. D. McName, “Robotised assays,” Lancet, 346: 114 (1995).

The beneficial effects of combinatorial chemistry and HTS are just beginning to be felt at the later stages of the drug pipeline. Some 40 drugs have emerged from HTS and made it to clinical trials. Directors from 50 HTS laboratories, participating in the study “High-Throughput Screening 2000: New Trends and Directions,” identified 46 drug candidates that originated in their HTS laboratories, and which are being tested in humans. The backlog of new chemical entities to be screened is monumental despite the continual operation of robots assaying those entities. “Screening,” Drug Discovery/Technology News, 4 (2001).

Lab directors are seeking technologies to facilitate higher throughput, reduce the use of scarce compounds, cells, membranes, and reagents, and to lower reagent costs. New technologies in HTS have significantly increased throughput and reduced assay volumes. Key advances over the past few years include new fluorescence methods, detection platforms, and liquid-handling technologies. Screening 100,000 samples per day in miniaturized assay volumes will soon become routine. Hertzberg et al., “High-throughput screening: new technology for the 21st century,” Curr. Opin. Chem. Biol., 4:445-51 (2000).

The milling technologies described above are useful in preparing nanoparticulate active agents, but are limited in several ways in the context of HTS. First, the mills themselves are sophisticated and expensive. Second, the production of candidate compounds in numbers large enough to be amendable to such milling technologies may be wholly uneconomical in the early stages of drug discovery. Thus, it would be desirable to produce very small quantities of active agents in nanoparticulate form. Third, it is impractical, if not impossible, to rapidly and simultaneously mill large numbers of small quantities of active agents. A method of doing so would be ideally wed to HTS methods, thereby providing a way of milling and screening many candidate compounds in a relatively short time.

D. Solubility of Drug Candidates

The synergistic and multiple interactions between rational drug design, recombinant biotechnology, combinatorial chemistry, and HTS result in millions of compounds being synthesized by chemists. However, development of these candidate compounds has often been impeded, if not terminated, due to biopharmaceutic and/or pharmacokinetic constraints related to poor solubility of candidate compounds. This has resulted in delays in development time and escalation of cost in the drug research programs. Panchagnula et al., “Biopharmaceutics and pharmacokinetics in drug research,” Int. J. Pharm., 201:131-50 (May 25, 2000).

Drug solubility remains one of the most challenging aspects in formulation development. Leuner et al., “Improving Drug Solubility for Oral Delivery Using Solid Dispersions,” Eur. J. Pharm. Biopharm., 50:47-60 (2000). With the advent of combinatorial chemistry and HTS, the number of poorly soluble compounds has dramatically increased. Although solid solutions have tremendous potential for improving drug solubility, forty years of research have resulted in only a few marketed products using this approach. Id.

The determination of solubility or dispersibility in a HTS environment is invaluable in the selection of the most promising potential drug candidates. This is because the level of permeability or solubility needed for oral absorption correlates to potency. The importance of poor solubility and poor permeability as they relate to the problem of poor oral absorption depends on the research approach used for lead generation. Current research approaches tend to result in a large number of poorly soluble drug candidates. For example, both “rational drug design” and HTS approaches lead to time-dependent higher molecular weight, higher hydrogen-bonding properties, unchanged lipophilicity, and, hence, poorer permeability. Id.

One method used to determine the solubility of potential drug candidates (usually from combinatorial chemistry) prior to HTS is based on laser nephelometry, where the drug candidates can be supplied as dimethyl sulfoxide (DMSO) solutions in 96-well plates. Bevan et al., “A high-throughput screening method for the determination of aqueous drug solubility using laser nephelometry in microtiter plates,” Anal. Chem., 72:1781-7 (Apr. 15, 2000). However, this method does not increase the solubility of a drug candidate, as it merely determines whether the drug is sufficiently soluble to warrant further study.

Another method of increasing the solubility of a compound prior to HTS is to dissolve the compound in a solvent, although such a solvent can be toxic and can interfere with the activity of the compound.

The present invention satisfies these needs and others by providing a method of milling very small quantities of one or more candidate compounds, including poorly water soluble candidate compounds. The resultant array of compounds are ideally poised for evaluation in HTS methods to determine the pharmaceutical efficacy and bioavailability of the candidate compounds.

### SUMMARY OF THE INVENTION

A first embodiment of the invention is a method of milling small quantities of one or more candidate compounds, comprising: (1) distributing a very small quantity of one or more candidate compounds in an apparatus having one or more compartments for milling in the presence of attrition milling media; and (2) agitating the candidate compound dispersions such that at least one of the one or more candidate compounds are reduced to an effective average particle size of less than about 2 microns. The attrition milling media can be added to the one or more compartments of the apparatus either before, during, or after addition of the one or more candidate compounds. Each candidate compound is present in a liquid dispersion medium in which the candidate compound is poorly soluble.

The milling process can be performed in the presence of at least one surface stabilizer, or at least one surface stabilizer can be added to the candidate compound dispersion(s) following particle size reduction. The surface stabilizer adsorbs to or associates with the surface of the candidate compound, and does not chemically interact with the candidate compound or itself.

In another embodiment, the invention encompasses first solubilizing one or more poorly water-soluble drug candidates in an appropriate solvent. The solubilized drug is dispensed into one or more compartments of the milling apparatus, following which the solvent is allowed to evaporate. Afterwards, water or an aqueous solution of surface stabilizer is added to each sample, followed by milling. This embodiment of the invention is significant in that the drug can be dispensed in liquid form which is very compatible with current HTS robotic equipment.

The products of the milling process are one or more dispersions of nanoparticulate candidate compounds. In one embodiment of the invention, the nanoparticulate candidate compounds have one or more surface stabilizers adsorbed on or associated with the surface of the candidate compounds. The reduction in particle size results in an increase in the solubility and/or dispersibility of the candidate compounds, thus increasing the effectiveness of HTS conducted in conjunction with the milling process. The particle size reduction can be conducted before HTS to make candidate compounds more soluble and/or more dispersible, or after HTS to validate a candidate compound determined to be active after screening. The liquid dispersion resulting from the milling process can be used directly in HTS.

A second embodiment of the invention is directed to a HTS method comprising: (1) distributing a plurality of candidate compounds in an apparatus having one or more compartments for milling in the presence of attrition milling media, wherein each candidate compound is present in a liquid dispersion medium in which the candidate compound is poorly soluble; (2) agitating the candidate compound dispersions such that at least one of the candidate compounds are reduced to an effective average particle size of less than about 2 microns; and (3) screening the resultant nanoparticulate candidate compounds in a conventional HTS assay to determine if one or more candidate compounds exhibit a desired activity. The milling process can be performed in the presence of at least one surface stabilizer, or at least one surface stabilizer can be added to the candidate compound dispersion following particle size reduction. The surface stabilizer adsorbs to or associates with the surface of the candidate compound, and does not chemically interact with the candidate compound or itself.

A third embodiment of the invention is a method of HTS comprising: (1) subjecting one or more candidate compounds to a conventional HTS assay to determine if one or more of the candidate compounds exhibit a desired activity; (2) distributing the candidate compounds exhibiting the desired activity in an apparatus having one or more compartments for milling in the presence of attrition milling media, wherein each candidate compound is present in a liquid dispersion medium in which the candidate compound is poorly soluble; and (3) agitating the candidate compound dispersions such that at least one of the candidate compounds is reduced to an effective average particle size of less than about 2 microns. The milling process can be performed in the presence of at least one surface stabilizer, or at least one surface stabilizer can be added to the candidate compound dispersion following particle size reduction. The resultant nanoparticulate candidate compounds exhibiting the desired activity can then be evaluated to determine if the candidate compounds have acceptable solubility, dispersibility, or both.

Both the foregoing general description and the following brief description of the drawings and detailed description are exemplary and explanatory and are intended to provide further explanation of the invention as claimed. Other objects, advantages, and novel features will be readily apparent to those skilled in the art from the following detailed description of the invention.

### BRIEF DESCRIPTION OF THE DRAWINGS

FIG. 1A: Shows a photomicrograph of 5% raw unmilled nystatin (mean size 1 2.88 μm);

FIG. 1B: Shows a photomicrograph of 5% nystatin+1% Na Deoxycholate in 5% DOSS after milling for 20 hours using a multiwell technique (mean size: 0.160 μm);

FIG. 1C: Shows a photomicrograph of 1% raw unmilled Compound A (mean size: 6.571 μm);

FIG. 1D: Shows a photomicrograph of 1% Compound A +0.5% PVP K29/32 after milling for 48 hours using a multiwell technique (mean size: 0.173 μm);

FIG. 2A: Shows a photomicrograph of a drug prior to milling;

FIG. 2B: Shows a photomicrograph of a drug after milling using a multiwell technique; and

FIG. 3: Shows a photomicrograph of a drug after milling using a multiwell technique.

### DETAILED DESCRIPTION OF THE PREFERRED EMBODIMENTS

The present invention is directed to methods of milling very small quantities of one or more candidate compounds to a nanoparticulate particle size. The methods are particularly beneficial in drug discovery activities when the methods are used in conjunction with HTS assays.

A first advantage of the milling methods is that very small quantities of candidate compounds can be milled to a nanoparticulate size, thereby conserving costly and limited quantities of candidate compounds identified, for example, in drug discovery.

A second advantage is that multiple candidate compounds can be milled simultaneously, thus significantly reducing the time required to prepare nanoparticulate dispersions of the candidate compounds.

A third advantage is that many combinations of a candidate compound and different surface stabilizers can be simultaneously milled, which with conventional milling techniques would otherwise require the use of many mills or multiple milling batches.

A fourth advantage of the milling methods is that simple, readily available equipment, such as multiwell plates, can be utilized for the milling apparatus, thus significantly reducing the cost of the milling method as compared to conventional milling methods requiring complex milling machines.

A fifth advantage of the methods of the invention is that the milled candidate compound dispersions can be used directly in HTS by aliquoting the correct concentration into compartments or wells for use in standard HTS screens. Additionally, the concentration can vary between different compartments or wells of the HTS assay. Milled candidate compound dispersions can also be used in other enzymatic or cellular tests of activity and toxicity.

Other advantages of the invention include that the milled dispersion does not contain high concentrations of toxic solvent, and that the candidate compound dispersion requires very little reformulation work for clinical studies.

Nanoparticulate candidate compound dispersions prepared according to the invention are stable for extensive periods of time, i.e., for a year or more. Thus, the nanoparticulate compound dispersions of the invention need not be immediately screened in a HTS or other type of assay following milling.

The time required to prepare a milled nanoparticulate dispersion from a given amount of starting material varies widely, depending upon the energy input into the system, i.e. whether low, medium, or high energy milling is used. Hundreds or thousands of candidate compounds can be comfortably milled within a working day with several multi-compartment milling apparatuses. The time limiting factors are preparation, harvesting, and particle sizing of the milled dispersions.

The present invention is described herein using several definitions that are set forth below and throughout the specification.

“About” will be understood by persons of ordinary skill in the art and will vary to some extent on the context in which the term is used. If there are uses of the term that are not clear to persons of ordinary skill in the art given the context in which it is used, “about” will mean up to plus or minus 10% of the particular term.

“Conventional” or “non-nanoparticulate active agent” means an active agent that is solubilized or that has an effective average particle size of greater than about 2 microns. “Effective average particle size of greater than about 2 microns” means that at least 50% of the particles of the composition have a size greater than about 2 microns.

As used herein, “nanoparticulate” refers to particulate active agent compositions having an effective average particle size of less than about 2 microns. “Effective average particle size of less than about 2 microns” means that at least 50% of the particles of the composition have a size less than about 2 microns.

“Pharmaceutically acceptable” as used herein refers to those compounds, materials, compositions, and/or dosage forms which are, within the scope of sound medical judgment, suitable for use in contact with the tissues of human beings and animals without excessive toxicity, irritation, allergic response, or other problem or complication, commensurate with a reasonable benefit/risk ratio.

“Pharmaceutically acceptable salts” as used herein refers to derivatives wherein the parent compound is modified by making acid or base salts thereof. Examples of pharmaceutically acceptable salts include, but are not limited to, mineral or organic acid salts of basic residues such as amines; alkali or organic salts of acidic residues such as carboxylic acids; and the like. The pharmaceutically acceptable salts include the conventional non-toxic salts or the quaternary ammonium salts of the parent compound formed, for example, from non-toxic inorganic or organic acids. For example, such conventional non-toxic salts include those derived from inorganic acids such as hydrochloric, hydrobromic, sulfuric, sulfamic, phosphoric, nitric, and the like; and the salts prepared from organic acids such as acetic, propionic, succinic, glycolic, stearic, lactic, malic, tartaric, citric, ascorbic, pamoic, maleic, hydroxymaleic, phenylacetic, glutamic, benzoic, salicylic, sulfanilic, 2-acetoxybenzoic, fumaric, toluenesulfonic, methanesulfonic, ethane disulfonic, oxalic, isethionic, and the like.

“Poorly soluble active agents” as used herein means active agents having a solubility in at least one liquid dispersion medium of less than about 30 mg/ml, preferably less than about 20 mg/ml, preferably less than about 10 mg/ml, preferably less than about 1 mg/ml, or preferably less than about 0.1 mg/ml. Such active agents tend to be eliminated from the gastrointestinal tract before being absorbed into the circulation. Moreover, poorly water soluble active agents tend to be unsafe for intravenous administration techniques, which are used primarily in conjunction with highly water soluble active agents.

As used herein with reference to stable active agent particles, “stable” includes, but is not limited to, one or more of the following parameters: (1) that the active agent particles do not appreciably flocculate or agglomerate due to interparticle attractive forces, or otherwise significantly increase in particle size over time; (2) that the physical structure of the active agent particles is not altered over time, such as by conversion from an amorphous phase to crystalline phase; (3) that the active agent particles are chemically stable; and/or (4) where the active agent has not been subject to a heating step at or above the melting point of the active agent in the preparation of the compositions of the invention.

“Therapeutically effective amount” as used herein with respect to an active agent dosage, means a dosage that provides the specific pharmacological response for which the active agent is administered in a significant number of subjects in need of such treatment. A “therapeutically effective amount,” administered to a particular subject in a particular instance, will not always effectively treat the diseases described herein, even though such dosage is deemed a ‘therapeutically effective amount’ by those skilled in the art. Throughout this description, active agent dosages are, in particular instances, measured as oral dosages, or with reference to active agent levels as measured in blood.

A. Candidate Compounds

The candidate compound is not limited to a substance having pharmaceutical activity, as the invention is intended to encompass any and all compounds which are either poorly soluble in at least one liquid medium, or which can be rendered poorly soluble in at least one liquid medium, and which may have a desired activity. The desired activity can be useful, for example, in pharmaceuticals, cosmetics, diagnostics, bioengineering, or agriculture.

The one or more candidate compounds exist in a crystalline phase, semi-crystalline phase, amorphous phase, semi-amorphous phase, in a liquid state at or near room temperature, or a combination thereof.

The one or more candidate compounds must be poorly soluble in at least one liquid medium. A preferred liquid dispersion medium is water. However, the invention can be practiced with other liquid media in which a candidate compound is poorly soluble and dispersible including, for example, aqueous salt solutions, safflower oil, and solvents such as ethanol, t-butanol, hexane, and glycol. The pH of aqueous dispersion media can be adjusted by techniques known in the art.

If a candidate compound is not poorly soluble, it can be converted to a salt or conjugated to other molecules or moieties to render the compound poorly soluble prior to milling. For example, the candidate compound can be conjugated to hydrophobic molecules, molecules with amphipathic properties, lipid molecules, phospholipid molecules, fats, prenyl groups, or palmitoyl groups to render the candidate compound less soluble or poorly soluble prior to milling. Such conjugation can be through direct conjugation to specific sites on the compound, to the N-terminal or C-terminal residue of the compound via intermediate spacer molecules which can be attached to one or more sites on the compound, and/or through internal side chains on the compound.

Additionally, a compound can be rendered less soluble by addition of amino acid residues either during the chemical synthesis or the biological expression of the compound. Suitable amino acid residues are those or their derivatives with hydrophobic properties. Such residues or motifs can be separated from the compound by hydrolysable linkers or linkers which can be cleaved in vivo, for example, by specified enzymes or esterases.

1. Exemplary Pharmaceutical and Nutraceutical Candidate Compounds

Exemplary candidate compounds include COX-2 inhibitors, anticancer agents, NSAIDS, proteins, peptides, nutraceuticals, anti-obesity agents, corticosteroids, elastase inhibitors, analgesics, anti-fungals, oncology therapies, anti-emetics, analgesics, cardiovascular agents, anti-inflammatory agents, anthelmintics, anti-arrhythmic agents, antibiotics, anticoagulants, antidepressants, antidiabetic agents, antiepileptics, antihistamines, antihypertensive agents, antimuscarinic agents, antimycobacterial agents, antineoplastic agents, immunosuppressants, antithyroid agents, antiviral agents, anxiolytics, sedatives, astringents, beta-adrenoceptor blocking agents, blood products and substitutes, cardiac inotropic agents, contrast media, cough suppressants, diagnostic agents, diagnostic imaging agents, diuretics, dopaminergics, haemostatics, immunological agents, lipid regulating agents, muscle relaxants, parasympathomimetics, parathyroid calcitonin and biphosphonates, prostaglandins, radio-pharmaceuticals, sex hormones, anti-allergic agents, stimulants and anoretics, sympathomimetics, thyroid agents, vasodilators, xanthines, acne medication, alpha-hydroxy formulations, cystic-fibrosis therapies, asthma therapies, emphysema therapies, respiratory distress syndrome therapies, chronic bronchitis therapies, chronic obstructive pulmonary disease therapies, organ-transplant rejection therapies, therapies for tuberculosis and other infections of the lung, and respiratory illness therapies associated with acquired immune deficiency syndrome.

Examples of representative active agents useful in this invention include, but are not limited to, acyclovir, alprazolam, altretamine, amiloride, amiodarone, benztropine mesylate, bupropion, cabergoline, candesartan, cerivastatin, chlorpromazine, ciprofloxacin, cisapride, clarithromycin, clonidine, clopidogrel, cyclobenzaprine, cyproheptadine, delavirdine, desmopressin, diltiazem, dipyridamole, dolasetron, enalapril maleate, enalaprilat, famotidine, felodipine, furazolidone, glipizide, irbesartan, ketoconazole, lansoprazole, loratadine, loxapine, mebendazole, mercaptopurine, milrinone lactate, minocycline, mitoxantrone, nelfinavir mesylate, nimodipine, norfloxacin, olanzapine, omeprazole, penciclovir, pimozide, tacolimus, quazepam, raloxifene, rifabutin, rifampin, risperidone, rizatriptan, saquinavir, sertraline, sildenafil, acetyl-sulfisoxazole, temazepam, thiabendazole, thioguanine, trandolapril, triamterene, trimetrexate, troglitazone, trovafloxacin, verapamil, vinblastine sulfate, mycophenolate, atovaquone, atovaquone, proguanil, ceftazidime, cefuroxime, etoposide, terbinafine, thalidomide, fluconazole, amsacrine, dacarbazine, teniposide, and acetylsalicylate.

Illustrative nutraceuticals include, but are not limited to, dietary supplements, vitamins, minerals, herbs, healing foods that have medical or pharmaceutical effects on the body, folic acid, fatty acids, fruit and vegetable extracts, vitamin supplements, mineral supplements, phosphatidylserine, lipoic acid, melatonin, glucosamine/chondroitin, Aloe Vera, Guggul, glutamine, amino acids, green tea, lycopene, whole foods, food additives, herbs, phytonutrients, antioxidants, flavonoid constituents of fruits, evening primrose oil, flax seeds, fish and marine animal oils, and probiotics.

a. Anticancer Active Agents

Useful anticancer agents are preferably selected from alkylating agents, antimetabolites, natural products, hormones and antagonists, and miscellaneous agents, such as radiosensitizers.

Examples of alkylating agents include: (1) alkylating agents having the bis-(2-chloroethyl)-amine group such as, for example, chlormethine, chlorambucile, melphalan, uramustine, mannomustine, extramustinephoshate, mechlore-thaminoxide, cyclophosphamide, ifosfamide, and trifosfamide; (2) alkylating agents having a substituted aziridine group such as, for example, tretamine, thiotepa, triaziquone, and mitomycine; (3) alkylating agents of the alkyl sulfonate type, such as, for example, busulfan, piposulfan, and piposulfam; (4) alkylating N-alkyl-N-nitrosourea derivatives, such as, for example, carmustine, lomustine, semustine, or streptozotocine; and (5) alkylating agents of the mitobronitole, dacarbazine and procarbazine type.

Examples of antimetabolites include: (1) folic acid analogs, such as, for example, methotrexate; (2) pyrimidine analogs such as, for example, fluorouracil, floxuridine, tegafur, cytarabine, idoxuridine, and flucytosine; and (3) purine derivatives such as, for example, mercaptopurine, thioguanine, azathioprine, tiamiprine, vidarabine, pentostatin, and puromycine.

Examples of natural products include: (1) vinca alkaloids, such as, for example, vinblastine and vincristine; (2) epipodophylotoxins, such as, for example, etoposide and teniposide; (3) antibiotics, such as, for example, adriamycine, daunomycine, doctinomycin, daunorubicin, doxorubicin, mithramycin, bleomycin, and mitomycin; (4) enzymes, such as, for example, L-asparaginase; (5) biological response modifiers, such as, for example, alpha-interferon; (6) camptothecin; (7) taxol; and (8) retinoids, such as retinoic acid.

Examples of hormones and antagonists include: (1) adrenocorticosteroids, such as, for example, prednisone; (2) progestins, such as, for example, hydroxyprogesterone caproate, medroxyprogesterone acetate, and megestrol acetate; (3) estrogens, such as, for example, diethylstilbestrol and ethinyl estradiol; (4) antiestrogens, such as, for example, tamoxifen; (5) androgens, such as, for example, testosterone propionate and fluoxymesterone; (6) antiandrogens, such as, for example, flutamide; and (7) gonadotropin-releasing hormone analogs, such as, for example, leuprolide.

Examples of miscellaneous agents include: (1) radiosensitizers, such as, for example, 1,2,4-benzotriazin-3-amine 1,4-dioxide (SR 4889) and 1,2,4-benzotriazine-7-amine 1,4-dioxide (WIN 59075); (2) platinum coordination complexes such as cisplatin and carboplatin; (3) anthracenediones, such as, for example, mitoxantrone; (4) substituted ureas, such as, for example, hydroxyurea; and (5) adrenocortical suppressants, such as, for example, mitotane and aminoglutethimide.

In addition, the anticancer agent can be an immunosuppressive drug, such as, for example, cyclosporine, azathioprine, sulfasalazine, methoxsalen, and thalidomide.

The anticancer agent can also be a COX-2 inhibitor.

b. Analgesics

An analgesic can be, for example, an NSAID or a COX-2 inhibitor.

Exemplary NSAIDS that can be formulated in compositions of the invention include, but are not limited to, suitable nonacidic and acidic compounds. Suitable nonacidic compounds include, for example, nabumetone, tiaramide, proquazone, bufexamac, flumizole, epirazole, tinoridine, timegadine, and dapsone. Suitable acidic compounds include, for example, carboxylic acids and enolic acids. Suitable carboxylic acid NSAIDs include, for example: (1) salicylic acids and esters thereof, such as aspirin, diflunisal, benorylate, and fosfosal; (2) acetic acids, such as phenylacetic acids, including diclofenac, alclofenac, and fenclofenac; (3) carbo- and heterocyclic acetic acids such as etodolac, indomethacin, sulindac, tolmetin, fentiazac, and tilomisole; (4) propionic acids, such as carprofen, fenbufen, flurbiprofen, ketoprofen, oxaprozin, suprofen, tiaprofenic acid, ibuprofen, naproxen, fenoprofen, indoprofen, and pirprofen; and (5) fenamic acids, such as flufenamic, mefenamic, meclofenamic, and niflumic. Suitable enolic acid NSAIDs include, for example: (1) pyrazolones such as oxyphenbutazone, phenylbutazone, apazone, and feprazone; and (2) oxicams such as piroxicam, sudoxicam, isoxicam, and tenoxicam.

Exemplary COX-2 inhibitors that can be formulated in combination with the nanoparticulate nimesulide composition of the invention include, but are not limited to, celecoxib (SC-58635, CELEBREX®, Pharmacia/Searle & Co.), rofecoxib (MK-966, L-748731, VIOXX®, Merck & Co.), meloxicam (MOBIC®, co-marketed by Abbott Laboratories, Chicago, Ill., and Boehringer Ingelheim Pharmaceuticals), valdecoxib (BEXTRA®, G. D. Searle & Co.), parecoxib (G. D. Searle & Co.), etoricoxib (MK-663; Merck), SC-236 (chemical name of 4-[5-(4-chlorophenyl)-3-(trifluoromethyl)-1H-pyrazol-1-yl)]benzenesulfonamide; G. D. Searle & Co., Skokie, Ill.); NS-398 (N-(2-cyclohexyloxy-4-nitrophenyl)methane sulfonamide; Taisho Pharmaceutical Co., Ltd., Japan); SC-58125 (methyl sulfone spiro(2.4)hept-5-ene I; Pharmacia/Searle & Co.); SC-57666 (Pharmacia/Searle & Co.); SC-558 (Pharmacia/Searle & Co.); SC-560 (Pharmacia/Searle & Co.); etodolac (Lodine®, Wyeth-Ayerst Laboratories, Inc.); DFU (5,5-dimethyl-3-(3-fluorophenyl)-4-(4-methylsulfonyl)phenyl 2(5H)-furanone); monteleukast (MK-476), L-745337 ((5-methanesulphonamide-6-(2,4-difluorothio-phenyl)-1-indanone), L-761066, L-761000, L-748780 (all Merck & Co.); DUP-697 (5-Bromo-2-(4-fluorophenyl)-3-(4-(methylsulfonyl)phenyl; DuPont Merck Pharmaceutical Co.); PGV 20229 (1-(7-tert.-butyl-2,3-dihydro-3,3-dimethylbenzo(b)furan-5-yl)-4-cyclopropylbutan-1-one; Procter & Gamble Pharmaceuticals); iguratimod (T-614; 3-formylamino-7-methylsulfonylamino-6-phenoxy-4H-1-benzopyran-4-one; Toyama Corp., Japan); BF 389 (Biofor, USA); CL 1004 (PD 136095), PD 136005, PD 142893, PD 138387, and PD 145065 (all Parke-Davis/Warner-Lambert Co.); flurbiprofen (ANSAID; Pharmacia & Upjohn); nabumetone (FELAFEN®; SmithKline Beecham, plc); flosulide (CGP 28238; Novartis/Ciba Geigy); piroxicam (FELDANE®; Pfizer); diclofenac (VOLTAREN® and CATAFLAM®, Novartis); lumiracoxib (COX-1 89; Novartis); D 1367 (Celltech Chiroscience, plc); R 807 (3 benzoyldifluoromethane sulfonanilide, diflumidone); JTE-522 (Japan Tobacco, Japan); FK-3311 (4′-Acetyl-2′-(2,4-difluorophenoxy)methanesulfonanilide), FK 867, FR 140423, and FR 11 5068 (all Fujisawa, Japan); GR 253035 (Glaxo Wellcome); RWJ 63556 (Johnson & Johnson); RWJ 20485 (Johnson & Johnson); ZK 38997 (Schering); S 2474 ((E)-(5)-(3,5-di-tert-butyl-4-hydroxybenzylidene)-2-ethyl-1,2-isothiazolidine-1,1-dioxide indomethacin; Shionogi & Co., Ltd., Japan); zomepirac analogs, such as RS 57067 and RS 104897 (Hoffmann La Roche); RS 104894 (Hoffmann La Roche); SC 41930 (Monsanto); pranlukast (SB 205312, Ono-1078, ONON®, ULTAIR®; SmithKline Beecham); SB 209670 (SmithKline Beecham); and APHS (heptinylsulfide).

2. Exemplary Candidate Compounds Useful in Dermal Applications

The candidate compounds according to the invention include but are not limited to candidate compounds which can be used in dermal applications, e.g., sunscreens, cosmetics, topical application of pharmaceuticals to the dermis (acne medication, anti-wrinkle drugs, such as alpha-hydroxy formulations), nail polish, moisturizers, deodorant, etc.

Other areas which benefit from the invention include coloring agents, flavors and fragrances. Coloring agents or pigments are used in cosmetic applications as well as in fabric applications. Suitable pigments can be inorganic and/or organic. Also included within the term pigment are materials having a low color or luster, such as matte finishing agents, and also light scattering agents. Examples of suitable pigments are iron oxides, acylglutamate iron oxides, ultramarine blue, D&C dyes, carmine, and mixtures thereof. Depending upon the type of cosmetic composition, e.g., foundation or blusher, a mixture of pigments will normally be used.

Fragrances and odiferous compounds are also suitable for use in the methods of the invention. Fragrances or perfumes are usually prepared from volatile oils distilled or extracted from the leaves, flowers, gums, or woods of plant life (occasionally from animal life). These include, for example, linalyl acetate from citral, jasmine, cedar, lavender, and attar of rose.

3. Exemplary Candidate Compounds Useful in Plant Tissue Applications

Yet another area of applicability of the invention includes nanoparticulate compositions that can be applied to plant tissue. Because of the difficulty in solubilizing some agricultural agents (i.e., some agricultural agents are applied as insoluble powders), the present invention provides a superior application method for plants as compared to prior art plant application methods.

In one embodiment of the invention, the candidate compound is an insecticidal ingredient applied to seeds, plants, trees, harvested crops, soil, and the like. The insecticide ingredient can be selected from a wide variety of organic compounds or mixtures which are known and used in agriculture and horticulture applications, such as those listed in W. T. Thomson, Agricultural Chemicals, Book I, Insecticides (Thomson Publications, Fresno, Calif. 1989).

The general categories of insecticidal-active organic compounds include chlorinated hydrocarbon derivatives, phosphorated derivatives, pyrethroids, acylureas, and the like. Chlorinated hydrocarbon insecticides usually act as stomach and contact poisons affecting the nervous system. They are persistent in the environment and tend to accumulate in animal fatty tissue, as exemplified by DDT and chlordane.

Illustrative of other insecticidal compounds are chlorfluazuron, chlorpyrifos, chlorpyrifos methyl, bromophos, diazinon, malathion, trichlorfon, dimethoate, phorate, lindane, toxaphene, diflubenuron, methomyl, propoxur, carbaryl, cyhexatin, cypermethrin, permethrin, fenvalerate, dicofol, tetradifon, propargite, and the like. Other examples of insecticides include the pyrethroid insecticides, such a Fenvalerate™ [α-cyano-3-phenoxybenzyl-2-(4-chlorophenyl)-3methylvalerate] and Pyrethroid™ [cyano(4-fluoro-3-phenoxyphenylmethyl-3-(2,2-dichloroethenyl)-2,2-dimethyl cyclopropanecarboxylate]; organophosphorus insecticides, such as DDVP™ (2,2-dichlorovinyldimethyl phosphate), Sumithion™ (dimethyl-4-nitro-m-tolylphosphorothionate), MalathoneTM {S-[1,2-bis(ethoxycarbonyl)ethyl]dimethyl-phosphorothiol thionate}, Dimethoate [dimethyl-S-(N-methylcarbamoylmethyl)-phosphorothios thionate), Elsan™ {S-[.alpha.-(ethoxycarbonyl)benzyl]dimethylphosphorothiol thionate), and Baycid™ [O,O-dimethyl-O-(3-methyl-4methylmercaptophenyl)thiophosphate]; carbamate; insecticides such as Bassa™ (O -butylphenyl methylcarbamate), MTMC™ (m-tolyl methylcarbamate), Meobal™ (3,4-dimethylphenyl-N-methylcarbamate), and NAC™ (1-naphthyl-N-methylcarbamate); as well as Methomyl™ {methyl-N[(methylcarbamoyl)oxy]thioacetimide} and Cartap™ {1,3-bis(carbamolythio)-2-(N,N-dimethylamino)propane hydrochloride}.

Examples of other agricultural agents include acaricides such as, but not limited to, Smite™ {2-[2-(p-tert-butylphenoxy)isopropoxy]isopropyl-2-chloroethyl sulfide}, Acricid™ (2,4-dinitro-6-sec-butylphenyl dimethylacrylate), Chlormit™ (isopropyl 4,4-dichlorobenzylate), Acar™ (ethyl 4,4-dichlorobenzylate), Kelthane™ [1,1-bis(p-chlorophenyl)-2,2,2-trichloroethanol], Citrazon™ (ethyl O-benzoyl-3-chloro-2,6-dimethoxybenzohydroxymate), Plictran™ (tricyclohexyltin hydroxide), and Omite™ [2-(p-tert-butylphenoxy)cyclohexyl-2-propinyl sulfite].

Examples of germicides include organosulfur germicides, such as Dithane™ (zinc ethylenebisdithiocarbamate), Maneo™ (manganese ethylenebis-dithiocarbamate), Thiuram™ [bis(dimethylthiocarbamoyl) disulfide ], Benlate™ [methyl 1-(butylcarbamoyl)-2-benzimidazole carbamate], Difolatan™ (N-tetrachloroethylthio-4-cyclohexane-1,2-dicarboxyimide), Daconol™ (tetrachloroisophthalonitrile), Pansoil™ (5-ethoxy-3-trichloromethyl-1,2,4-thiadiazole), Thiophanate-methyl[1,2-bis(3-methoxycarbonyl-2-thioureido) benzene], Rabcide™ (4,5,6,7-tetrachlorophthaloid), Kitazin P™ (O,O-diisopropyl-S-benzyl phosphorothioate), Hinonsan™ (0-ethyl-S,S-diphenyldithiophosphate), and Propenazol™ (3-allyloxy-1,2-benzothiazole 1,1-dioxide).

Examples of plant growth regulating agents include, but are not limited to, MH™ (maleic acid hydrazide) and Ethrel™ (2-chloroethylphosphonic acid).

Examples of herbicides include, but are not limited to Stam™ (3,4-dichloropropionanilide), Saturn™ [S-(4-chlorobenzyl) N,N-diethylthiolcarbamate), Lasso (2-chloro-2′,6′-diethyl-N-(methoxymethyl)acetanilide), Glyphosate™ [N-(phosphonomethyl)glycine isopropylamine salt], DCMU [3-(3,4-dichlorophenyl)-1,1-dimethylurea), and Gramoxone™ (1,1′-dimethyl-4,4′-dipyridium dichloride].

Other herbicides contemplated for use in the present invention include auxin transport inhibitors, e.g., naptalam; growth regulators, including benzoic acids, e.g., dicamba; phenoxy acids, such as (i) acetic acid type, e.g., 2,4-D, MCPA, (ii) propionic acid type, e.g., 2,4-DP, MCPP, and (iii) butyric acid type, e.g., 2,4-DB, MCPB; picolinic acids and related compounds, e.g., picloram, triclopyr, fluroxypyr, and clopyralid.

Photosynthesis inhibitors are also herbicides useful in the compositions of the invention. Such compounds include but are not limited to (a) s-triazines, such as (i) chloro substituted, e.g., atrazine, simazine, and cyanazine, (ii) methoxy substituted, e.g., prometon, (iii) methylthio substituted, e.g., ametryn and prometryn; (b) other triazines, such as hexazinone, and metribuzin; (c) substituted ureas, such as diuron, fluometuron, linuron, tebuthiuron, thidiazuron, and forchlorfenuron; (d) uracils, such as bromacil and terbacil; and (e) others, such as bentazon, desmedipham, pheninedipham, propanil, pyrazon, and pyridate.

Pigment inhibitors are also herbicides useful in the compositions of the invention. Such compounds include but are not limited to pyridazinones, such as norflurazon; isoxazolones, such as clomazone; and others, such as amitrole and fluridone.

In yet another aspect of the invention, growth inhibitors are herbicides useful in the compositions of the invention. Such compounds include but are not limited to (a) mitotic disruptors, such as (i) dinitroanilines, e.g., trifluralin, prodiamine, benefin, ethalfluralin, isopropalin, oryzalin, and pendimethalin; and (ii) others, such as DCPA, dithiopyr, thiazopyr, and pronamide; (b) inhibitors of shoots of emerging seedlings, such as (i) thiocarbamates, e.g., EPTC, butylate, cycloate, molinate, pebulate, thiobencarb, triallate, and vernolate; (c) inhibitors of roots only of seedlings, such as bensulide, napropamide, and siduron; and (d) inhibitors of roots and shoots of seedlings, including chloroacetamides, such as alachlor, acetochlor, metolachlor, diethatyl, propachlor, butachlor, pretilachlor, metazachlor, dimethachlor, and cinmethylin.

Amino acid synthesis inhibitors are herbicides useful in the compositions of the invention. Such compounds include, but are not limited to, (a) glyphosate, glufosinate; (b) sulfonylureas, such as rimsulfuron, metsulfuron, nicosulfuron, triasulfuron, primisulfuron, bensulfuron, chlorimuron, chlorsulfuron, sulfometuron, thifensulfuron, tribenuron, ethametsulfuron, triflusulfuron, clopyrasulfuron, pyrazasulfuron, prosulfuron (CGA-152005), halosulfuron, metsulfuron-methyl, and chlorimuron-ethyl; (c) sulfonamides, such as flumetsulam (a.k.a. DE498); (d) imidazolinones, such as imazaquin, imazamethabenz, imazapyr, imazethapyr, and imazmethapyr.

Lipid biosynthesis inhibitors are herbicides useful in the compositions of the invention. Such compounds include, but are not limited to, (a) cyclohexanediones, such as sethoxydim and clethodim; (b) aryloxyphenoxys, such as fluazifop-(P-butyl), diclofop-methyl, haloxyfop-methyl, and quizalofop; and (c) others, such as fenoxaprop-ethyl.

Cell wall biosynthesis inhibitors are herbicides useful in the compositions of the invention. Such compounds include, but are not limited to, dichlobenil and isoxaben.

Rapid cell membrane disruptors are herbicides useful in the compositions of the invention. Such compounds include, but are not limited to, (a) bipyridiliums, such as paraquat, and diquat; (b) diphenyl ethers, such as acifluorfen, fomesafen, lactofen, and oxyfluorfen; (c) glutamine synthetase inhibitors, such as glufosinate; and (d) others, such as oxadiazon.

Miscellaneous herbicides useful in the compositions of the invention include, but are not limited to, (a) carbamates, such as asulam; (b) nitriles, such as bromoxynil and ioxynil; (c) hydantocidin and derivatives; and (d) various other compounds, such as paclobutrazol, ethofumesate, quinclorac (a.k.a. BAS514), difenzoquat, endothall, fosamine, DSMA, and MSMA.

Other herbicides useful in the compositions of the invention include, but are not limited to, triketones and diones of the type described in U.S. Pat. Nos. 5,336,662 and 5,608,101, the contents of each of which are incorporated herein by reference, and in EP-A-338-992; EP-A-394-889; EP-A-506,967; EP-A-137,963; EP-A-186-118; EP-A-186-119; EP-A-186-120; EP-A-249-150; and EP-A-336-898. Examples of such triketones and diones are sulcotrione (MIKADO™), whose chemical designation is 2-(2-chloro-4-methanesulfonylbenzoyl)-1,3-cyclohexanedione: 2-(4-methylsulfonyloxy-2-nitrobenzoyl)-4,4,6,6-tetramethyl-1,3-cyclohexane dione; 3-(4-methylsulfonyloxy-2-nitrobenzoyl)-bicyclo[3,2,1]octane-2,4-dione3-(4-methylsulfonyl-2-nitrobenzoyl)-bicyclo[3,2,1 ]octane-2,4-dione; 4-(4-chloro-2-nitrobenzoyl)-2,6,6-trimethyl-2H-1,2-oxazine-3,5(4H,6H)dione ; 4-(4-methylthio-2-nitrobenzoyl)-2,6,6-trimethyl-2H-1,2-oxazine-3,5(4H,6H) -dione; 3-(4-methylthio-2-nitrobenzoyl)-bicyclo[3,2,1]octane-2,4-dione; 4-(2-nitro-4-trifluoromethoxybenzoyl)-2,6,6-trimethyl-2H-1,2-oxazine-3,5(4 H,6H)-dione.

Useful herbicidal candidate compounds are described in U.S. Pat. No. 5,506,192; EP-A-461,079; EP-A-549,524; EP-A-315,589 and PCT Appln. No. 91/10653. The contents of all of the cited references are incorporated herein by reference; including for example 3-[(4,6-dimethoxy-2-pyrimidinyl)hydroxymethyl]-N-methyl-2-pyridine carboxamide; 4,7-dichloro-3-(4,6-dimethoxy-2-pyrimidinyl)-3-hexanoyloxyphthalide; 3-[(4,6-dimethoxy-2-pyrimidinyl)carbonyl]-N,N-dimethyl-2-pyridine carboxamide; 3,6-dichloro-2-[(4,6-dimethoxy-2-pyrimidinyl)carbonyl]benzoic acid; 6-chloro-2-[(4,6-dimethoxy-2-pyrimidinyl)thio]benzoic acid (a.k.a. DPX-PE350 or pyrithiobac) and salts and derivatives thereof.

B. Surface Stabilizers

In one embodiment of the invention, one or more surface stabilizers are adsorbed on or associated with the surface of the candidate compound in an amount sufficient to maintain the compound at an effective average particle size of less than about 2 microns. The surface stabilizer can be added to the liquid dispersion medium either before, during, or after size reduction of candidate compounds.

Useful surface stabilizers, which are known in the art and described, for example, in U.S. Pat. No. 5,145,684, specifically incorporated by reference, are believed to include those which physically adhere to the surface of the candidate compound but do not chemically interact with the compound or itself. Furthermore, preferably the individual molecules of the surface stabilizer are essentially free of intermolecular cross-linkages. Two or more surface stabilizers can be employed for each candidate compound in the methods of the invention.

Suitable surface stabilizers are selected from known organic and inorganic pharmaceutical excipients. Such excipients include various polymers, low molecular weight oligomers, natural products, and surfactants. Preferred surface stabilizers include nonionic and ionic surface stabilizers, including anionic and cationic surface stabilizers.

Representative examples of surface stabilizers include cetyl pyridinium chloride, gelatin, casein, phosphatides, dextran, glycerol, gum acacia, cholesterol, tragacanth, stearic acid, stearic acid esters and salts, calcium stearate, glycerol monostearate, cetostearyl alcohol, cetomacrogol emulsifying wax, sorbitan esters, polyoxyethylene alkyl ethers, polyoxyethylene castor oil derivatives, polyoxyethylene sorbitan fatty acid esters, polyethylene glycols, dodecyl trimethyl ammonium bromide, polyoxyethylene stearates, colloidal silicon dioxide, phosphates, sodium dodecylsulfate, carboxymethylcellulose calcium, hydroxypropyl celluloses, hydroxypropyl methylcellulose, carboxymethylcellulose sodium, methylcellulose, hydroxyethylcellulose, hydroxypropylmethyl-cellulose phthalate, noncrystalline cellulose, magnesium aluminum silicate, triethanolamine, polyvinyl alcohol, polyvinylpyrrolidone, 4-(1,1,3,3-tetramethylbutyl)-phenol polymer with ethylene oxide and formaldehyde, poloxamers, poloxamines, a charged phospholipid, dimyristoyl phophatidyl glycerol, dioctylsulfosuccinate, dialkylesters of sodium sulfosuccinic acid, sodium lauryl sulfate, alkyl aryl polyether sulfonates, mixtures of sucrose stearate and sucrose distearate, triblock copolymers of the structure: —(—PEO)—(—PBO—)—(—PEO—)—, p-isononylphenoxypoly-(glycidol), decanoyl-N-methylglucamide; n-decyl β-D-glucopyranoside, n-decyl β-D-maltopyranoside, n-dodecyl β-D-glucopyranoside, n-dodecyl β-D-maltoside, heptanoyl-N-methylglucamide, n-heptyl-β-D-glucopyranoside, n-heptyl β-D-thioglucoside, n-hexyl β-D-glucopyranoside, nonanoyl-N-methylglucamide, n-noyl β-D-glucopyranoside, octanoyl-N-methylglucamide, n-octyl-β-D-glucopyranoside, octyl β-D-thioglucopyranoside, lysozyme, a PEG derivatized phospholipid, PEG derivatized cholesterol, a PEG derivatized cholesterol derivative, PEG derivatized vitamin A, PEG derivatized vitamin E, and random copolymers of vinyl acetate and vinyl pyrrolidone.

A particularly preferred surface stabilizer is a cationic surface stabilizer selected from a polymer, a biopolymer, a polysaccharide, a cellulosic, an alginate, a nonpolymeric compound, and a phospholipid. Exemplary surface stabilizers in this context include cationic lipids, benzalkonium chloride, sulfonium compounds, phosphonium compounds, quarternary ammonium compounds, benzyl-di(2-chloroethyl)ethylammonium bromide, coconut trimethyl ammonium chloride, coconut trimethyl ammonium bromide, coconut methyl dihydroxyethyl ammonium chloride, coconut methyl dihydroxyethyl ammonium bromide, decyl triethyl ammonium chloride, decyl dimethyl hydroxyethyl ammonium chloride, decyl dimethyl hydroxyethyl ammonium chloride bromide, C₁₂₋₁₅dimethyl hydroxyethyl ammonium chloride, C₁₂₋₁₅dimethyl hydroxyethyl ammonium chloride bromide, coconut dimethyl hydroxyethyl ammonium chloride, coconut dimethyl hydroxyethyl ammonium bromide, myristyl trimethyl ammonium methyl sulphate, lauryl dimethyl benzyl ammonium chloride, lauryl dimethyl benzyl ammonium bromide, lauryl dimethyl (ethenoxy)₄ ammonium chloride, lauryl dimethyl (ethenoxy)₄ ammonium bromide, N-alkyl (C₁₂₋₁₈)dimethylbenzyl ammonium chloride, N-alkyl (C₁₄₋₁₈)dimethyl-benzyl ammonium chloride, N-tetradecylidmethylbenzyl ammonium chloride monohydrate, dimethyl didecyl ammonium chloride, N-alkyl and (C₁₂₋₁₄) dimethyl 1-napthylmethyl ammonium chloride, trimethylammonium halide, alkyl-trimethylammonium salts, dialkyl-dimethylammonium salts, lauryl trimethyl ammonium chloride, ethoxylated alkyamidoalkyldialkylammonium salt, an ethoxylated trialkyl ammonium salt, dialkylbenzene dialkylammonium chloride, N-didecyldimethyl ammonium chloride, N-tetradecyldimethylbenzyl ammonium, chloride monohydrate, N-alkyl(C₁₂₋₁₄) dimethyl 1-naphthylmethyl ammonium chloride, dodecyldimethylbenzyl ammonium chloride, dialkyl benzenealkyl ammonium chloride, lauryl trimethyl ammonium chloride, alkylbenzyl methyl ammonium chloride, alkyl benzyl dimethyl ammonium bromide, C₁₂trimethyl ammonium bromides, C₁₅trimethyl ammonium bromides, C₁₇ trimethyl ammonium bromides, dodecylbenzyl triethyl ammonium chloride, poly-diallyldimethylammonium chloride (DADMAC), dimethyl ammonium chlorides, alkyldimethylammonium halogenides, tricetyl methyl ammonium chloride, decyltrimethylammonium bromide, dodecyltriethylammonium bromide, tetradecyltrimethylammonium bromide, methyl trioctylammonium chloride, POLYQUAT 10™ (cationic cellulose), tetrabutylammonium bromide, benzyl trimethylammonium bromide, choline esters, benzalkonium chloride, stearalkonium chloride compounds, cetyl pyridinium bromide, cetyl pyridinium chloride, halide salts of quaternized polyoxyethylalkylamines, MIRAPOL™, ALKAQUAT™, alkyl pyridinium salts; amines, amine salts, amine oxides, imide azolinium salts, protonated quaternary acrylamides, methylated quaternary polymers, cationic guar, polymethylmethacrylate trimethylammonium bromide, polyvinylpyrrolidone-2-dimethylaminoethyl methacrylate dimethyl sulfate, hexadecyltrimethyl ammonium bromide, poly (2-methacryloxyethyltrimethylammonium bromide) (S1001), poly(N-vinylpyrrolidone/2-dimethylaminoethyl methacrylate) di methylsulphate quarternary (S1002), and poly(2-methylacryloxyamidopropyltrimethylammonium chloride) (S1004).

Most of these surface stabilizers are known pharmaceutical excipients and are described in detail in the Handbook of Pharmaceutical Excipients, published jointly by the American Pharmaceutical Association and The Pharmaceutical Society of Great Britain (The Pharmaceutical Press, 1995), specifically incorporated by reference. The surface stabilizers are commercially available and/or can be prepared by techniques known in the art.

C. Concentration of the Candidate Compound/Surface Stabilizer

The relative amount of the candidate compound and surface stabilizer in the dispersion present in each compartment of the milling apparatus can vary widely. The optimal amount of the surface stabilizer can depend, for example, upon the particular compound and surface stabilizer selected or the critical micelle concentration of the surface stabilizer if it forms micelles.

The candidate compound is preferably present in the liquid dispersion medium in an amount from about 99.99% to about 0.001%, from about 95% to about 0.1%, and from about 90% to about 0.5%, by weight, based on the total combined dry weight of the candidate compound and at least one surface stabilizer, not including other excipients.

The surface stabilizer is preferably present in the liquid dispersion medium in an amount selected from the group consisting of from about 0.01% to about 99.999%, about 5% to about 99.9%, and about 10% to about 99.5%, by weight, based on the total dry weight of the candidate compound and surface stabilizer, not including other excipients.

D. Compound/Surface Stabilizer Particle Size

The one or more candidate compounds are reduced to an effective average particle size of less than about 2 microns. As used herein, particle size is determined on the basis of the weight average particle size as measured by conventional particle size measuring techniques well known to those skilled in the art. Such techniques include, for example, sedimentation field flow fractionation, photon correlation spectroscopy, light scattering, and disk centrifugation.

In other embodiments of the invention, the candidate compounds also can be reduced to an effective average particle size of less than about 1900 nm, less than about 1800 nm, less than about 1700 nm, less than about 1600 nm, less than about 1500 nm, less than about 1400 nm, less than about 1300 nm, less than about 1200 nm, less than about 1100 nm, less than about 1000 nm, less than about 900 nm, less than about 800 nm, less than about 700 nm, less than about 600 nm, less than about 500 nm, less than about 400 nm, less than about 300 nm, less than about 250 nm, less than about 200 nm, less than about 1 50 nm, less than about 100 nm, less than about 75 nm, or less than about 50 nm, as measured by light-scattering methods, microscopy, or other appropriate methods.

By “an effective average particle size of less than about 2 microns” it is meant that at least 50% of the active agent particles have a particle size less than the effective average, by weight, i.e., less than about 2 microns, 1900 nm, 1800 nm, etc., when measured by the above-noted techniques. Preferably, at least about 70%, at least about 80%, at least about 90%, at least about 95%, or at least about 99% of the active agent particles have an effective average particle size less than the effective average, i.e., less than about 2 microns, 1900 nm, 1800 nm, 1700 nm, etc.

In the present invention, the value for D50 of a nanoparticulate active agent composition is the particle size below which 50% of the active agent particles fall, by weight. Similarly, D90 is the particle size below which 90% of the active agent particles fall, by weight.

E. Quantity of Candidate Compound; Dispersion Volume Required

As mentioned above, very small quantities of candidate compounds can be milled using the methods of the invention. The amount of drug that can be processed is primarily driven by the size of the milling chamber or compartment and the volume of media used.

In one embodiment of the invention, the milling chamber size and media volume are chosen such that the quantity of candidate compound required for the particle size reduction process can be up to about 1 kg. In other embodiments of the invention, the quantity of candidate compound can be less than about 1 kg, less than about 800 mg, less than about 600 mg, less than about 500 mg, less than about 400 mg, less than about 300 mg, less than about 200 mg, less than about 100 mg, less than about 75 mg, or less than about 50 mg.

In another embodiment of the invention, the milling chamber size and media volume are chosen such that the quantity of candidate compound required for the particle size reduction process is less than about 100 mg, less than about 90 mg, less than about 80 mg, less than about 70 mg, less than about 60 mg, less than about 50 mg, less than about 40 mg, less than about 30 mg, less than about 25 mg, less than about 20 mg, less than about 15 mg, less than about 10 mg, less than about 5 mg, less than about 4 mg, less than about 3 mg, less than about 2 mg, less than about 1 mg, less than about 0.75 mg, less than about 0.5 mg, less than about 0.25 mg, less than about 0.1 mg, or less than about 0.05 mg.

The one or more candidate compounds are present in the liquid dispersion medium at a concentration of less than about 70%, less than about 60%, less than about 50%, less than about 40%, less than about 30%, less than about 25%, less than about 20%, less than about 1 5%, less than about 10%, less than about 5%, less than about 4%, less than about 3%, less than about 2%, less than about 1%, less than about 0.5%, less than about 0.1%, less than about 0.01%, or less than about 0.001%.

The total dispersion volume required for the particle size reduction process is dependent upon the amount of drug to be milled and the size of the milling chamber or compartment. The media volume can be less than about 15 mL, less than about 10 mL, less than about 9 mL, less than about 8 mL less than about 7 mL, less than about 6 mL, less than about 5 mL, less than about 4 mL, less than about 3 mL, less than about 2 mL, less than about 1.75 mL less than about 1.5 mL, less than about 1.25 mL less than about 1 mL, less than about 0.75 mL less than about 0.5 mL, less than about 0.25 mL, or less than about 0.1 mL.

F. Attrition Media

The attrition media used in the one or more compartments of the milling apparatus can be any suitable media. Preferably, the media is rigid and spherical or particulate in form. The selection of material for the attrition media is not believed to be critical. Exemplary attrition media include, but are not limited to, zirconium oxide, such as 95% ZrO stabilized with magnesia, zirconium silicate, glass, stainless steel, titania, alumina, ceramic, 95% ZrO stabilized with yttrium, and polymeric attrition media. Preferred attrition media have a density greater than about 3 g/cm³.

In one embodiment of the invention, polymeric attrition media is employed. The polymeric media can be made of a polymeric resin, or the core of the media can be made of a non-polymeric compound which is coated with a polymeric compound. For example, useful polymeric media includes, but is not limited to, particles formed of polystyrene or cross-linked polystyrene. U.S. Pat. Nos. 5,518,187, 5,718,388, and 5,862,999, which are specifically incorporated by reference, disclose milling pharmaceutical products using polymeric attrition media.

Useful attrition media preferably have a particle size of about 3 mm or less, about 2 mm or less, about 1 mm or less, about 500 microns or less, about 400 microns or less, about 300 microns or less, about 200 microns or less, about 100 microns or less, or about 50 microns or less. Mixtures of different attrition media particle sizes can also be used in the invention. For example, mixtures of attrition media of about 200 microns and about 50 microns, or a mixture of sizes ranging between about 50 and about 500 microns, are useful.

G. Mill Structure and Exemplary Milling Method

The methods of the invention utilize an apparatus comprised of at least one milling compartment, but preferably two or more milling compartments. The compartments can be integrated into a single construct in fixed positions. An example of this type of apparatus is a commercially available multi-well plate, such as a 96 well plate. Alternatively, the compartments can be reversibly fixed, allowing a user to position the compartments into any desired configuration. For example, the compartments can be arranged with respect to each other in any pattern, but preferably appear in regular patterns, such as lines or orthogonal arrays, or even as curves, such as circles. Consequently, it is possible to establish known gradients of candidate compound, surface stabilizer concentrations, different surface stabilizers, different candidate compounds, or combinations thereof. Thus, a single candidate compound can be milled using a range of unique surface stabilizers. Alternatively, multiple candidate compounds may be milled simultaneously with one or more surface stabilizers. Preferably, each compartment contains one candidate compound, although compartments can contain mixtures of candidate compounds.

In an alternative configuration, the apparatus may comprise compartments comprised of separate receptacles that can be inserted into cavities embedded within a construct. Thus, each compartment can be manipulated, filled, and emptied independently of other compartments.

The size of a compartment can vary and thus may be adapted to any dispersion medium volume.

An exemplary apparatus comprises one or more multiwell plates, the wells of which serve as independent milling compartments. One or more of such plates can be affixed to a magnetic orbital mixer to provide the required agitation, or magnetic stir bars or another suitable apparatus can be utilized to provide the required agitation. Mixers adapted for use with multiwell plates are commercially available (e.g., Sigma-Aldrich, Milwaukee, Wis.). The mixer is driven by a conventional laboratory magnetic stirrer. Each plate may have as few as a single well or as many as 96 wells or more. In one embodiment of the invention, each plate has 24 to 48 wells. Such multiwell plates have the advantage of being inexpensive and commercially available. Illustrative plates include polystyrene multiwell plates used commonly for tissue culture work (e.g., Sigma-Aldrich, Milwaukee, Wis.).

In an exemplary milling method, the compartments of an apparatus as described above are independently charged with one or more candidate compounds, surface stabilizers, dispersion media, and attrition media, and then sealed. The milling action is achieved by agitating the compartments for a time sufficient to effect a reduction in particle size of at least one of the candidate compounds to less than about 2 microns. This may be accomplished, for example, by rapidly vibrating the compartments. The vibrating can be an orbital motion, a back-and-forth motion, or a combination of these motions.

The time required for particle size reduction is about 10 days or less, about 9 days or less, about 8 days or less, about 7 days or less, about 6 days or less, about 5 days or less, about 4 days or less, about 3 days or less, about 72 hours or less, about 48 hours or less, about 36 hours or less, about 24 hours or less, about 12 hours or less, about 6 hours or less, about 1 hour or less, about 45 minutes or less, about 30 minutes or less, and about 15 minutes or less.

H. HTS Methods

In one embodiment of the invention, following particle size reduction by the milling method described herein, the one or more candidate compounds are screened simultaneously in a conventional HTS assay to determine if one or more of the candidate compounds exhibit a desired activity. A mixture of two or more candidate compounds can be screened, and the nanoparticulate candidate compound dispersion can be used directly in the HTS assay.

The HTS assay can be any standard screen, such as an enzymatic or whole cell assay. Additionally, the assay can be manual or automatic.

In one embodiment of the invention, cationic surface stabilizers are used in HTS methods employing whole cell assays. Without wishing to bound by any particular theory, it is believed that the positive charge of a cationic surface stabilizer promotes attractive interactions between the cells and nanoparticulate candidate compounds, thereby giving rise to increased cellular absorption and/or response. Additionally, such attractive interactions are believed to account for greater accuracy and decreased assay time during HTS.

In another embodiment of the invention, multiple candidate compounds are first screened in a conventional HTS assay as described above to determine if one or more of the candidate compounds exhibits a desired activity. Those candidate compounds possessing such activity are then reduced to a particle size of about 2 microns or less according to the milling method of this invention. The resultant nanoparticulate candidate compounds having known activities are then evaluated to determine whether they also exhibit acceptable solubility, dispersibility, or a combination thereof.

The following examples are-given to illustrate the present invention. It should be understood, however, that the invention is not to be limited to the specific conditions or details described in these examples. Throughout the specification, any and all references to a publicly available documents are specifically incorporated into this patent application by reference.

### EXAMPLE 1

The purpose of this example was to demonstrate low energy milling of naproxen using an agitated 24-well microplate format.

Preliminary testing suggested that optimal results are obtained for the flat-bottom multiwell format when about 1 g of milling media is used for each 250 μl of drug slurry. Initial testing also revealed that comparable results are obtained when either 0.5 mm or 0.8 mm media is used. In this example 0.8 mm media was used.

Naproxen and hydroxypropyllcellulose (HPC-SL) as a surface stabilizer were combined at a drug:stabilizer ratio of 4:1. Samples of the composition and grinding media, as shown in the table below, were added to the wells of a 24-well microplate One well was used for each condition. The microplate was then agitated at the maximum sustainable speed using an orbital shaking platform driven by a standard laboratory magnetic stirring device. After 48 hours the average particle size of naproxen was estimated by light microscopy.

TABLE 1

| Amount of | 0.8 mm Grinding | Slurry | Average Particle |
|---|---|---|---|
| Drug (mg) | Media (g) | Volume (ml) | Size of Naproxen |
| 10 | 2 | 0.5 | <0.5 μm |
| 5 | 1 | 0.25 | <0.5 μm |
| 2.5 | 1 | 0.25 | <0.5 μm |
| 1.25 | 1 | 0.25 | <1 μm, |
| 0.5 | 2 | 0.5 | <1 μm, |
| 0.25 | 1 | 0.25 | <1 μm, |

The results show that particle size reduction can successfully be conducted in a 24 well microplate format, producing stable nanoparticulate active agent compositions having average particle sizes of less than about 2 microns. The results also reveal that it is possible to mill quantities of drug as low as 250 μg.

### EXAMPLE 2

The purpose of this example was to demonstrate low energy milling of naproxen using an agitated 48-well microplate format.

Naproxen and hydroxypropyllcellulose (HPC-SL) as a surface stabilizer were combined at a drug:stabilizer ratio of 4:1. Samples of the composition and grinding media, as shown in the table below, were added to the wells of a 48-well microplate. One well was used for each condition. The microplate was then agitated at the maximum sustainable speed using an orbital shaking platform driven by a standard laboratory magnetic stirring device. After 48 hours, the average particle size of naproxen was estimated by light microscopy.

TABLE 2

| Amount of | 0.8 mm Grinding | Slurry | Average Particle |
|---|---|---|---|
| Drug (mg) | Media (g) | Volume (ml) | Size |
| 2.5 | 0.5 | 0.125 | <0.5 μm |
| 1.25 | 0.5 | 0.125 | <0.5 μm |
| 0.625 | 0.5 | 0.125 | <1 μm |
| 0.125 | 0.5 | 0.125 | <1 μm |

The results show that particle size reduction can successfully be conducted in a 48 well microplate format, producing stable nanoparticulate active agent compositions having average particle sizes of less than about 2 microns. The results also reveal that it is possible to mill quantities of drug as low as 125 μg.

### EXAMPLE 3

To demonstrate that the technique described herein is applicable to formulating a range of poorly water-soluble drugs with distinct chemistries and modes of action, and furthermore that the results are comparable to those obtained by ball milling, seven different formulations were processed by the method of the present invention and by ball milling .

In each case, a slurry of unmilled drug and stabilizer in water was prepared and then dispensed as required in each well or bottle. Multiwell plates containing either 24 or 48 wells were used. On 48-well plates, twelve wells were processed in parallel for each formulation to yield enough material for particle size analysis by microscopy and laser light scattering. This was done for the purpose of validation only; the methods of particle size analysis used herein were optimized for analysis of larger quantities of material and it is expected that during use of this technique for HTS, different methods of particle size analysis optimized for smaller quantities of materials would be utilized.

The plate was then agitated at the maximum sustainable speed on a magnetically-driven orbital shaking platform. In parallel, 15 ml bottles containing 7.5 ml of 0.8 mm ceramic milling media and 3.75 ml of drug slurry were rolled at 1 70 rpm. Milling was stopped at the times indicated for particle size analysis. The results of the milling experiments are shown below—in Table 3.

TABLE 3

| | | | Agitated | | |
|---|---|---|---|---|---|
| | Ball Mill | | Microwell | | |
| | size | | size | | Unmilled |
| Formulation | (μm) | pH | (μm) | pH | drug size |
| 1% Nystatin + 0.5% Betadine | 0.283 | 7 | 0.566 | 5.6 | 12.88 |
| (24 hours milled) | | | | | |
| 5% Nystatin + 1% Na | 0.544 | 7.2 | 0.160 | 7.1 | 12.880 |
| Deoxycholate (20 hours milled) | | | | | |
| 1% Itraconazole + 0.25% F108 | 1.177 | 7 | 1.537 | 6.9 | 14.423 |
| (48 hours milled) | | | | | |
| 1% Compound A + 0.5% | 0.124 | 7.1 | 0.173 | 6.4 | 6.571 |
| PVP K29/32 (5 days milled) | | | | | |
| 1% Compound B + 0.5% | 0.885 | 9.1 | 0.539 | 7.4 | 23.036 |
| HPC-SL (48 hours milled) | | | | | |
| 2% Naproxen + 0.5% HPC-SL | 0.298 | 6.4 | 0.269 | 5.4 | 24.405 |
| (20 hours milled) | | | | | |
| 2% Paclitaxel + 1% Tyloxapol | 0.142 | 8.7 | 0.257 | 7.1 | 20.021 |
| (20 hours milled) | | | | | |

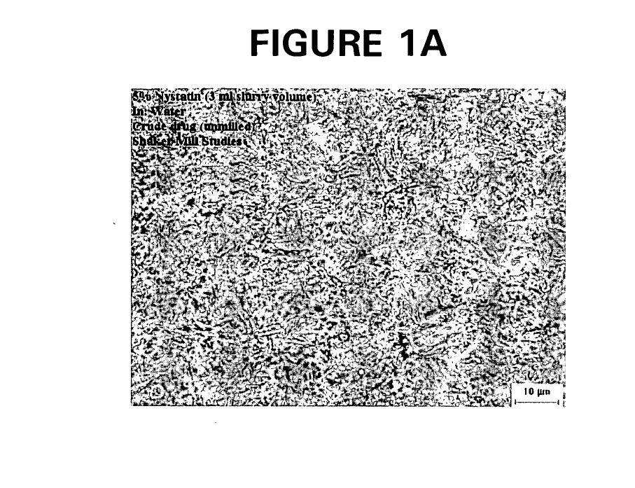

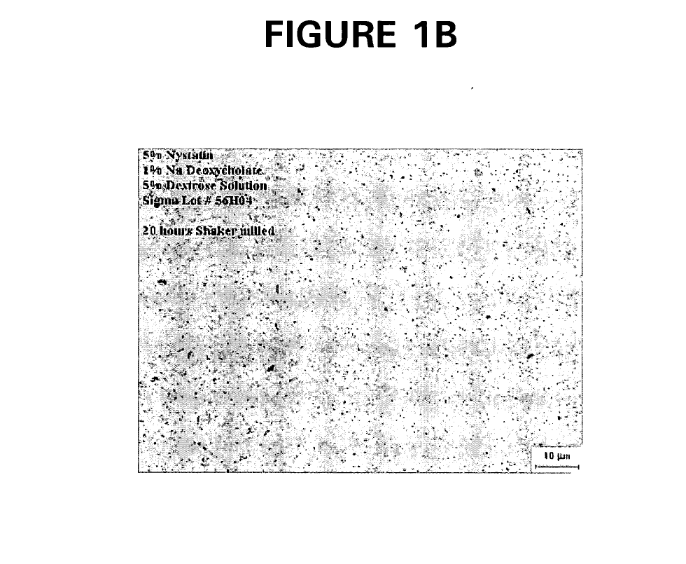

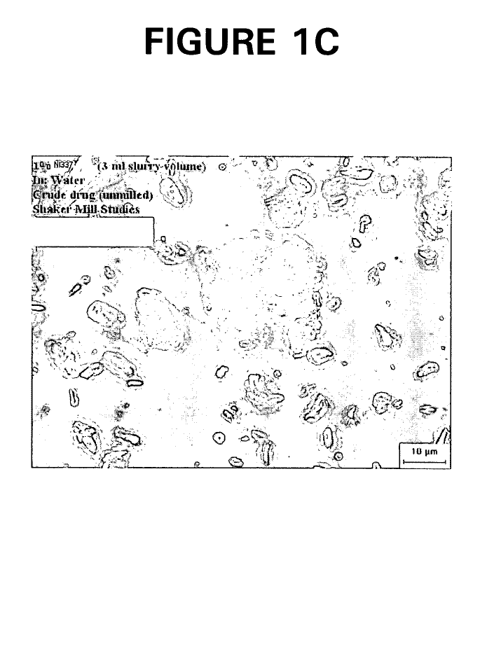

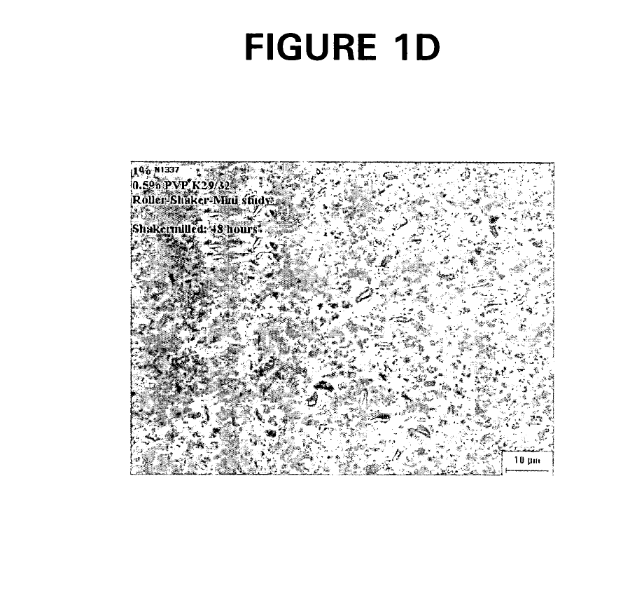

The results (particle size analysis and light microscopy) indicate that particle size was effectively reduced by the agitated multiwell technique in all formulation, regardless of drug identity. The results are further exemplified in FIGS. 1A through 1D, which show: 5% raw unmilled nystatin (mean size 12.88 μm) (FIG. 1A); 5% nystatin+1% Na Deoxycholate in 5% DOSS milled for 20 hours using a multiwell technique (mean size: 0.160 μm) (FIG. 1B); 1% raw unmilled Compound A (mean size: 6.571 μm) (FIG. 1C); and 1% Compound A+0.5% PVP K29/32 milled for 48 hours using a multiwell technique(mean size: 0.173 μm) (FIG. 1D).

The time taken to produce nanoparticulate dispersions was comparable to that of ball milling. This suggests that the general efficiency of the two low-energy milling approaches is comparable and that the method may be widely applicable to discovery formulation of a range of poorly water-soluble drug candidates.

### EXAMPLE 4

The purpose of this example was to use the milling method of the invention to determine the suitability of a surface stabilizer for a poorly water-soluble discovery compound.

A poorly water-soluble discovery compound, Compound C, was milled using a 48 well multiwell plate and orbital shaking platform to determine the suitability of the surface-modifier. The compound was milled in a single well containing 0.5 g of 0.8 mm media and 0.125 ml of 1% drug with 0.25% PVP K29/32. The sample was milled for 48 hours and then evaluated by light microscopy.

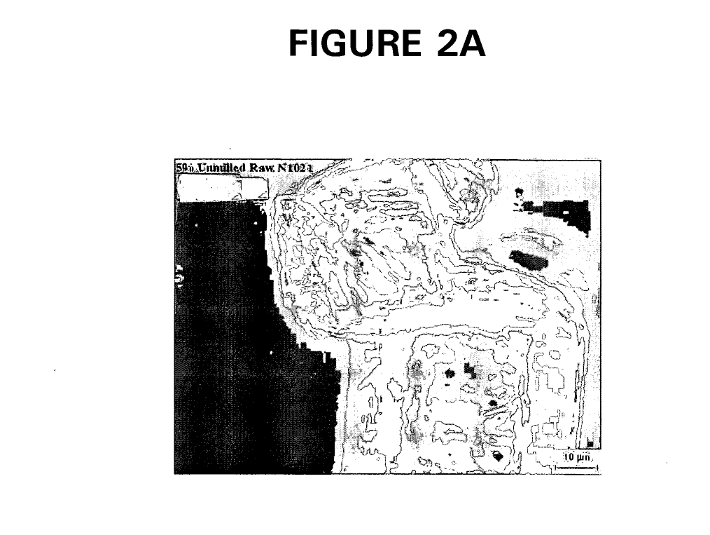

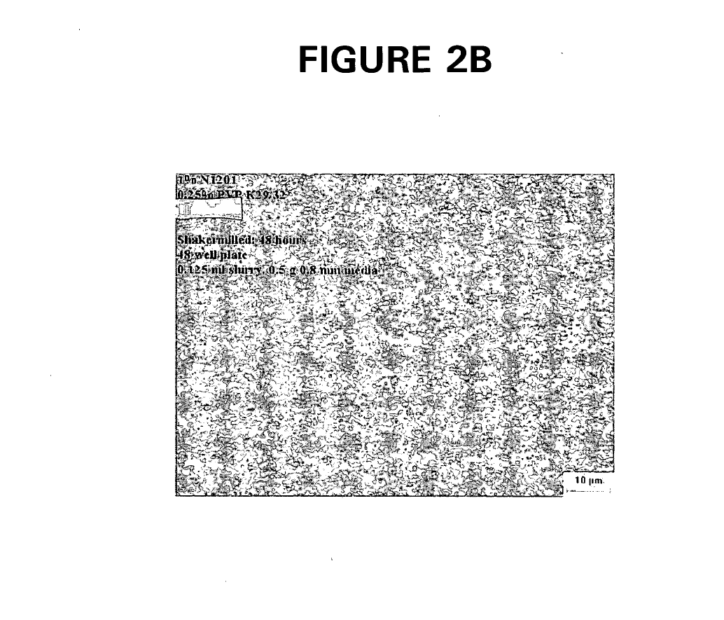

Micrographs of the drug sample taken before and after milling, shown in FIGS. 2A and 2B, respectively, demonstrate that particle size is reduced significantly by the agitated multiwell technique. Brownian motion of the particles was readily observed after milling, verifying that the particles were dispersed and not aggregated.

The results confirm that this surface stabilizer is capable of effectively stabilizing the drug particles, and suggest that this technique may be valuable as a screening tool to test the interaction of different stabilizers with different drugs.

### EXAMPLE 5

The purpose of this example was to demonstrate the feasibility of milling a poorly water-soluble discovery compound which is first solubilized in a solvent.

Compound C, a poorly water-soluble discovery compound shown in Example 4, was processed using a slightly different protocol than described above. In this example, Compound C was dissolved to a final concentration of 20 mg/ml in methanol with and without a surface stabilizer. An aliquot of 50 μl (1 mg of compound) was pippeted into each microplate well containing 0.8 mm ceramic milling media. The solvent was evaporated. Afterwards, 1 25 μl of water or 1% surface stabilizer solution was added to each well. The microplate was covered and placed on a shaker mill for 4 days. Processed samples were evaluated for particle size reduction using optical microscopy and light scattering instrumentation.

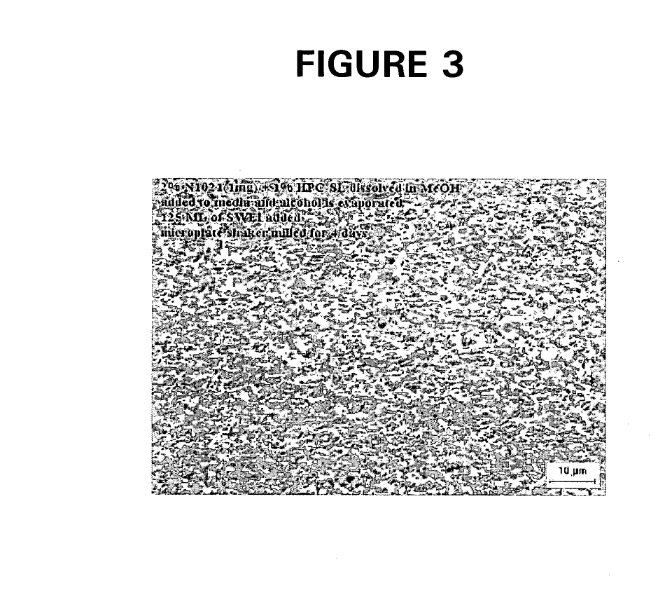

As shown in the optical micrograph (FIG. 3), a homogeneous population of nanoparticles was generated using 1 mg of drug. This example demonstrates that media milling can be accomplished using a stock solution, wherein 1 mg or less of a drug substance can be readily dispensed in liquid form and then processed.

Moreover, the optical micrograph (FIG. 3) shows a homogenous population of particles after 4 days of milling. Brownian motion of the particles was readily observed and there were no signs of large drug crystals and/or aggregation. Particle size measurements were obtained using Photon Correlation Spectroscopy. The mean particle size of the processed sample was—434 nm.

It will be apparent to those skilled in the art that various modifications and variations can be made in the methods and compositions of the present invention without departing from the spirit or scope of the invention. Thus, it is intended that the present invention cover the modifications and variations of this invention provided they come within the scope of the appended claims and their equivalents.

We claim:

1. A method of milling small quantities of one or more candidate compounds comprising:
(a) providing one or more candidate compounds in a liquid dispersion medium in which the candidate compound is poorly soluble;
(b) distributing less than about 15 mL of one or more candidate compound dispersions in at least one compartment of a milling apparatus in the presence of attrition milling media; and
(c) agitating the apparatus such that at least one of the one or more candidate compounds are reduced to an effective average particle size of less than about 2 microns,
wherein at least one surface stabilizer is added to the liquid dispersion medium, either before, during, or after milling.

2. The method of claim 1, wherein the apparatus comprises at least one multiwell plate.

3. The method of claim 2, wherein each well contains a single candidate compound.

4. The method of claim 3, wherein the candidate compound present in each compartment is the same as that present in other compartments of the apparatus, the candidate compound present in each compartment is different from that present in other compartments of the apparatus, or a combination thereof.

5. The method of claim 2, wherein the multiwell plate comprises 2 to 96 wells.

6. The method of claim 5, wherein the multiwell plate comprises 24 to 48 wells.

7. The method of claim 1, wherein the attrition milling media is selected from the group consisting of polymeric media, steel, glass, and ceramic.

8. The method of claim 1, wherein the attrition milling media has a particle size selected from the group consisting of about 3 mm or less, about 2 mm or less, about 1 mm or less, about 500 microns or less, about 400 microns or less, about 300 microns or less, about 200 microns or less, about 100 microns or less, about 50 microns or less, and mixtures thereof.

9. The method of claim 1, wherein the time required for the particle size reduction process is selected from the group consisting of about 10 days or less, about 9 days or less, about 8 days or less, about 7 days or less, about 6 days or less, about 5 days or less, about 4 days or less, about 3 days or less, about 72 hours or less, about 48 hours or less, about 36 hours or less, about 24 hours or less, about 12 hours or less, about 6 hours or less, about 1 hour or less, about 45 minutes or less, about 30 minutes or less, and about 15 minutes or less.

10. The method of claim 1, wherein the dispersion medium is selected from the group consisting of water, aqueous salt solutions, safflower oil, ethanol, t-butanol, hexane, and glycol.

11. The method of claim 1, wherein the total dispersion volume required for the particle size reduction process is selected from the group consisting of less than about 10 mL, less than about 9 mL, less than about 8 mL less than about 7 mL, less than about 6 mL, less than about 5 mL, less than about 4 mL, less than about 3 mL, less than about 2 mL, less than about 1.75 mL, less than about 1.5 mL, less than about 1.25 mL, less than about 1 mL, less than about 0.75 mL, less than about 0.5 mL, less than about 0.25 mL, or less than about 0.1 mL.

12. The method of claim 1, wherein each of the candidate compounds has a solubility in the liquid dispersion medium selected from the group consisting of less than about 30 mg/ml, less than about 20 mg/ml, less than about 10 mg/ml, less than about 1 mg/ml, and less than about 0.1 mg/ml.

13. The method of claim 1, wherein each of the candidate compounds is in the form of a salt or is conjugated to another substance to render the compound poorly soluble.

14. The method of claim 1, wherein the compounds are reduced to an effective average particle size selected from the group consisting of less than about 1900 nm, less than about 1800 nm, less than about 1700 nm, less than about 1600 nm, less than about 1500 nm, less than about 1400 nm, less than about 1300 nm, less than about 1200 nm, less than about 1100 nm, less than about 1000 nm, less than about 900 nm, less than about 800 nm, less than about 700 nm, less than about 600 nm, less than about 500 nm, less than about 400 nm, less than about 300 nm, less than about 250 nm, less than about 200 nm, less than about 150 nm, less than about 100 nm, less than about 75 nm, or less than about 50 nm.

15. The method of claim 14, wherein at least about 60%, at least about 70%, at least about 80%, at least about 90%, at least about 95%, or at least about 99% of the nanoparticles have a particle size less than the effective average particle size.

16. The method of claim 1, wherein the quantity of candidate compound required for the particle size reduction process selected from the group consisting of less than about 100 mg, less than about 90 mg, less than about 80 mg, less than about 70 mg, less than about 60 mg, less than about 50 mg, less than about 40 mg, less than about 30 mg, less than about 25 mg, less than about 20 mg, less than about 15 mg, less than about 10 mg, less than about 5 mg, less than about 4 mg, less than about 3 mg, less than about 2 mg, less than about 1 mg, less than about 0.75 mg, less than about 0.5 mg, less than about 0.25 mg, less than about 0.1 mg, and less than about 0.05 mg.

17. The method of claim 1, wherein the one or more candidate compounds are independently present in the liquid dispersion medium at a concentration selected from the group consisting of less than about 70%, less than about 60%, less than about 50%, less than about 40%, less than about 30%, less than about 25%, less than about 20%, less than about 15%, less than about 10%, less than about 5%, less than about 4%, less than about 3%, less than about 2%, less than about 1%, less than about 0.5%, less than about 0.1%, less than about 0.01%, and less than about 0.001%.

18. The method of claim 1, wherein the one or more candidate compounds are independently present in the liquid dispersion medium at a concentration selected from the group consisting of from about 99.99% to about 0.001%, from about 95% to about 0.1%, and from about 90% to about 0.5%, by weight, based on the total combined dry weight of the candidate compound and at least one surface stabilizer, not including other excipients.

19. The method of claim 1, wherein the one or more candidate compounds are selected from the group consisting of a crystalline compound, a semi-crystalline compound, an amorphous compound, a semi-amorphous compound, and a mixture thereof.

20. The method of claim 1, wherein the one or more candidate compounds are selected independently from the group consisting of therapeutic agents, cosmetics, diagnostic agents, agents useful in bioengineering, and agricultural agents.

21. The method of claim 20, wherein the candidate compounds are agricultural agents selected from the group consisting of pesticides, fertilizers, insecticides, and herbicides.

22. The method of claim 1, wherein at least one candidate compound is selected from the group consisting of COX-2 inhibitors, anticancer agents, NSAIDS, proteins, peptides, nutraceuticals, anti-obesity agents, corticosteroids, elastase inhibitors, analgesics, anti-fungals, oncology therapies, anti-emetics, analgesics, cardiovascular agents, anti-inflammatory agents, anthelmintics, anti-arrhythmic agents, antibiotics, anticoagulants, antidepressants, antidiabetic agents, antiepileptics, antihistamines, antihypertensive agents, antimuscarinic agents, antimycobacterial agents, antineoplastic agents, immunosuppressants, antithyroid agents, antiviral agents, anxiolytics, sedatives, astringents, beta-adrenoceptor blocking agents, blood products and substitutes, cardiac inotropic agents, contrast media, cough suppressants, diagnostic agents, diagnostic imaging agents, diuretics, dopaminergics, haemostatics, immunological agents, lipid regulating agents, muscle relaxants, parasympathomimetics, parathyroid calcitonin and biphosphonates, prostaglandins, radio-pharmaceuticals, sex hormones, anti-allergic agents, stimulants and anoretics, sympathomimetics, thyroid agents, vasodilators, xanthines, acne medication, alpha-hydroxy formulations, cystic-fibrosis therapies, asthma therapies, emphysema therapies, respiratory distress syndrome therapies, chronic bronchitis therapies, chronic obstructive pulmonary disease therapies, organ-transplant rejection therapies, therapies for tuberculosis and other infections of the lung, and respiratory illness therapies associated with acquired immune deficiency syndrome.

23. The method of claim 22, wherein the nutraceutical is selected from the group consisting of dietary supplements, vitamins, minerals, herbs, healing foods that have medical or pharmaceutical effects on the body, folic acid, fatty acids, fruit and vegetable extracts, vitamin supplements, mineral supplements, phosphatidylserine, lipoic acid, melatonin, glucosamine/chondroitin, Aloe Vera, Guggul, glutamine, amino acids, green tea, lycopene, whole foods, food additives, herbs, phytonutrients, antioxidants, flavonoid constituents of fruits, evening primrose oil, flax seeds, fish and marine animal oils, and probiotics.

24. The method of claim 1, wherein the at least one surface stabilizer is independently present in an amount selected from the group consisting of from about 0.01% to about 99.999%, about 5% to about 99.9%, and about 10% to about 99.5%, by weight, based on the total dry weight of the candidate compound and surface stabilizer, not including other excipients.

25. The method of claim 1, wherein at least two surface stabilizers are added to at least one candidate compound, either before or after milling.

26. The method of claim 1, wherein the at least one surface stabilizer is selected from the group consisting of a nonionic surface stabilizer, an anionic surface stabilizer, a cationic surface stabilizer, and an ionic surface stabilizer.

27. The method of claim 26, wherein the at least one surface stabilizer is selected from the group consisting of cetyl pyridinium chloride, gelatin, casein, phosphatides, dextran, glycerol, gum acacia, cholesterol, tragacanth, stearic acid, stearic acid esters and salts, calcium stearate, glycerol monostearate, cetostearyl alcohol, cetomacrogol emulsifying wax, sorbitan esters, polyoxyethylene alkyl ethers, polyoxyethylene castor oil derivatives, polyoxyethylene sorbitan fatty acid esters, polyethylene glycols, dodecyl trimethyl ammonium bromide, polyoxyethylene stearates, colloidal silicon dioxide, phosphates, sodium dodecylsulfate, carboxymethylcellulose calcium, hydroxypropyl celluloses, hydroxypropyl methylcellulose, carboxymethylcellulose sodium, methylcellulose, hydroxyethylcellulose, hydroxypropylmethyl-cellulose phthalate, noncrystalline cellulose, magnesium aluminum silicate, triethanolamine, polyvinyl alcohol, polyvinylpyrrolidone, 4-(1,1,3,3-tetramethylbutyl)-phenol polymer with ethylene oxide and formaldehyde, poloxamers, poloxamines, a charged phospholipid, dimyristoyl phophatidyl glycerol, dioctylsulfosuccinate, dialkylesters of sodium sulfosuccinic acid, sodium lauryl sulfate, alkyl aryl polyether sulfonates, mixtures of sucrose stearate and sucrose distearate, triblock copolymers of the structure: —(—PEO)—(—PBO—)—(—PEO—)—, p-isononylphenoxypoly-(glycidol), decanoyl-N-methylglucamide; n-decyl β-D-glucopyranoside, n-decyl β-D-maltopyranoside, n-dodecyl β-D-glucopyranoside, n-dodecyl β-D-maltoside, heptanoyl-N-methylglucamide, n-heptyl-β-D-glucopyranoside, n-heptyl β-D-thioglucoside, n-hexyl β-D-glucopyranoside, nonanoyl-N-methylglucamide, n-noyl β-D-glucopyranoside, octanoyl-N-methylglucamide, n-octyl-β-D-glucopyranoside, octyl β-D-thioglucopyranoside, lysozyme, a PEG derivatized phospholipid, PEG derivatized cholesterol, a PEG derivatized cholesterol derivative, PEG derivatized vitamin A, PEG derivatized vitamin E, and random copolymers of vinyl acetate and vinyl pyrrolidone.

28. The method of claim 26, wherein at least one cationic surface stabilizer is selected from the group consisting of a polymer, a biopolymer, a polysaccharide, a cellulosic, an alginate, a nonpolymeric compound, and a phospholipid.

29. The method of claim 26, wherein the at least one surface stabilizer is selected from the group consisting of cationic lipids, benzalkonium chloride, sulfonium compounds, phosphonium compounds, quarternary ammonium compounds, benzyl-di(2-chloroethyl)ethylammonium bromide, coconut trimethyl ammonium chloride, coconut trimethyl ammonium bromide, coconut methyl dihydroxyethyl ammonium chloride, coconut methyl dihydroxyethyl ammonium bromide, decyl triethyl ammonium chloride, decyl dimethyl hydroxyethyl ammonium chloride, decyl dimethyl hydroxyethyl ammonium chloride bromide, C₁₂₋₁₅dimethyl hydroxyethyl ammonium chloride, C₁₂₋₁₅dimethyl hydroxyethyl ammonium chloride bromide, coconut dimethyl hydroxyethyl ammonium chloride, coconut dimethyl hydroxyethyl ammonium bromide, myristyl trimethyl ammonium methyl sulphate, lauryl dimethyl benzyl ammonium chloride, lauryl dimethyl benzyl ammonium bromide, lauryl dimethyl (ethenoxy)₄ammonium chloride, lauryl dimethyl (ethenoxy)4ammonium bromide, N-alkyl (C₁₂₋₁₈)dimethylbenzyl ammonium chloride, N-alkyl (C₁₄₋₁₈)dimethyl-benzyl ammonium chloride, N-tetradecylidmethylbenzyl ammonium chloride monohydrate, dimethyl didecyl ammonium chloride, N-alkyl and (C₁₂₋₁₄) dimethyl 1-napthylmethyl ammonium chloride, trimethylammonium halide, alkyl-trimethylammonium salts, dialkyl-dimethylammonium salts, lauryl trimethyl ammonium chloride, ethoxylated alkyamidoalkyldialkylammonium salt, an ethoxylated trialkyl ammonium salt, dialkylbenzene dialkylammonium chloride, N-didecyldimethyl ammonium chloride, N-tetradecyldimethylbenzyl ammonium, chloride monohydrate, N-alkyl(C₁₂₋₁₄) dimethyl 1-naphthylmethyl ammonium chloride, dodecyldimethylbenzyl ammonium chloride, dialkyl benzenealkyl ammonium chloride, lauryl trimethyl ammonium chloride, alkylbenzyl methyl ammonium chloride, alkyl benzyl dimethyl ammonium bromide, C₁₂trimethyl ammonium bromides, C₁₅trimethyl ammonium bromides, C₁₇trimethyl ammonium bromides, dodecylbenzyl triethyl ammonium chloride, poly-diallyldimethylammonium chloride (DADMAC), dimethyl ammonium chlorides, alkyldimethylammonium halogenides, tricetyl methyl ammonium chloride, decyltrimethylammonium bromide, dodecyltriethylammonium bromide, tetradecyltrimethylammonium bromide, methyl trioctylammonium chloride, POLYQUAT 10™, tetrabutylammonium bromide, benzyl trimethylammonium bromide, choline esters, benzalkonium chloride, stearalkonium chloride compounds, cetyl pyridinium bromide, cetyl pyridinium chloride, halide salts of quaternized polyoxyethylalkylamines, MIRAPOL™, ALKAQUAT™, alkyl pyridinium salts; amines, amine salts, amine oxides, imide azolinium salts, protonated quaternary acrylamides, methylated quaternary polymers, cationic guar, polymethylmethacrylate trimethylammonium bromide, polyvinylpyrrolidone-2-dimethylaminoethyl methacrylate dimethyl sulfate, hexadecyltrimethyl ammonium bromide, poly (2-methacryloxyethyltrimethylammonium bromide) (S1001), poly(N-vinylpyrrolidone/2-dimethylaminoethyl methacrylate) di methylsulphate quarternary (S1002), and poly(2-methylacryloxyamidopropyltrimethylammonium chloride) (S1004).

30. The method of claim 1, wherein:
(a) the one or more candidate compounds are provided in a solvent in which the candidate compounds are dissolved;
(b) the dissolved candidate compounds are distributed into one or more compartments of a milling apparatus;
(c) the solvent is evaporated;
(d) water or a surface stabilizer solution is added to the compartments of the milling apparatus; and
(e) agitating the milling apparatus such that at least one of the one or more candidate compounds are reduced to an effective average particle size of less than about 2 microns.

31. A high throughput screening method comprising:
(a) providing one or more candidate compounds in a liquid dispersion medium in which the candidate compound is poorly soluble;
(b) distributing less than about 15 mL of one or more candidate compound dispersions in at least one compartment of a milling apparatus in the presence of attrition milling media;
and
(c) agitating the apparatus such that at least one of the one or more candidate compounds are reduced to an effective average particle size of less than about 2 microns, wherein at least one surface stabilizer is added to the liquid dispersion medium in each well comprising candidate compound, either before, during, or after milling; and
(d) screening the candidate compounds obtained in step (c) in a conventional high throughput screening assay to determine if one or more of the candidate compounds exhibits a desired activity.

32. The method of claim 31, wherein the high throughput screening assay is an enzymatic or whole cell assay.

33. The method of claim 31, wherein the one or more milled candidate compounds obtained in (c) are used directly in the high throughput screening assay in (d).

34. The method of claim 31, wherein the high throughput screening assay is automatic.

35. The method of claim 31, wherein a mixture of two or more candidate compounds is screened in (c).

36. The method of claim 31, wherein
(a) the one or more candidate compounds are provided in a solvent in which the candidate compounds are dissolved;
(b) the dissolved candidate compounds are distributed into one or more compartments of a milling apparatus;
(c) the solvent is evaporated;
(d) water or a surface stabilizer solution is added to the compartments of the milling apparatus; and
(e) agitating the milling apparatus such that at least one of the one or more candidate compounds are reduced to an effective average particle size of less than about 2 microns.

37. A high throughput screening method comprising:
(a) screening one or more candidate compounds in a conventional high throughput screening assay to determine if one or more of the candidate compounds exhibit a desired activity;
(b) formulating the one or more candidate compounds exhibiting a desired activity into a dispersion in which the one or more candidate compounds are poorly soluble;
(c) distributing less than about 15 mL of one or more candidate compound dispersions in at least one compartment of a milling apparatus in the presence of attrition milling media; and
(d) agitating the apparatus such that at least one of the one or more candidate compounds are reduced to an effective average particle size of less than about 2 microns, wherein at least one surface stabilizer is added to the liquid dispersion medium in each well comprising candidate compound, either before, during, or after milling; and
(e) determining if the one or more candidate compounds exhibiting the desired activity have acceptable solubility, dispersibility, or a combination thereof.

38. The method of claim 37, wherein the high throughput screening assay is an enzymatic or whole cell assay.

39. The method of claim 37, wherein the high throughput screening assay is automatic.

40. The method of claim 37, wherein a mixture of two or more candidate compounds is screened in (a).

41. The method of claim 37, wherein:
(a) the one or more candidate compounds are provided in a solvent in which the candidate compounds are dissolved;
(b) the dissolved candidate compounds are distributed into one or more compartments of a milling apparatus;
(c) the solvent is evaporated;
(d) water or a surface stabilizer solution is added to the compartments of the milling apparatus; and
(e) agitating the milling apparatus such that at least one of the one or more candidate compounds are reduced to an effective average particle size of less than about 2 microns.
